(19) United States
(12) Patent Application Publication
(10) Pub. No.: US 2026/0301458 A1
(43) Pub. Date: Oct. 1, 2026

(54) IMAGING-BASED PHARMACEUTICAL CONTENT VERIFICATION IN A ROBOTIC PREPARATION SYSTEM

(71) Applicant: EQUASHIELD MEDICAL LTD, Migdal Tefen (IL)

(72) Inventor: Osnat PERRY, Harduf (IL)

(21) Appl. No.: 19/488,912

(22) PCT Filed: May 30, 2024
(86) PCT No.: PCT/IL2024/050536

§ 371 Date: Dec. 1, 2025

Related U.S. Application Data
(60) Provisional application No. 63/470,353, filed on Jun. 1, 2023.

(51) Int. Cl. G06V 30/40; G06N 3/08

(52) U.S. Cl. CPC G06V 30/40; G06N 3/08

(57) ABSTRACT

Label image information is used to automatically identify and/or verify the identification of pharmaceutical substances, in conjunction with the automatic preparation of pharmaceutical preparations from those pharmaceutical substances. In some examples, textual content of substance containers is identified using OCR. This corresponds to a significant portion of the label information intended for human inspection. As a cross-check, one or more additional visual aspects of the label are evaluated, e.g., an aspect of graphical appearance other than textual content as such. Optionally, risks of mis-identification are evaluated. Optionally, imperfect matches to templates are deemed permissible due to a low risk of actual misidentification, and/or close but potentially ambiguous template matches are deemed insufficiently risk free, resulting in mitigation actions.

### CROSS-REFERENCE TO RELATED APPLICATIONS

This application is a national phase filing under 35 C.F.R. § 371 of and claims priority to PCT Patent Application No. PCT/IL2024/050536, filed on May 30, 2024, which claims the benefit of priority of U.S. Provisional Patent Application No. 63/470,353, filed on Jun. 1, 2023.

The contents of this reference are incorporated herein by reference in their entirety.

### FIELD AND BACKGROUND OF THE DISCLOSURE

The presently disclosed subject matter, in some embodiments thereof, relates to the field of imaging in robotics, and more particularly, but not exclusively, to implementation of systems for specification and/or verification of robotic preparation of pharmaceutical doses.

Automatic pharmaceutical preparation systems perform mixing of pharmaceutical substances to a common container, starting from reagents which may be supplied separated among a plurality of containers.

Pharmaceutical substances are typically supplied in labeled containers. Labeling is typically subject to regulations and best practices, within the bounds of which individual manufacturers have a certain amount of design leeway.

### SUMMARY OF THE DISCLOSURE

According to an aspect of some examples of the presently described subject matter, there is provided a method of identifying a pharmaceutical substance, comprising: accessing at least one image of a label of a pharmaceutical substance container; accessing one or more label templates, the data of each label template including: textual content of a region of a reference label, and at least one indication of graphical appearance in the region of the reference label; comparing the image to the one or more label templates, including comparison to both the textual content and the at least one indication of graphical appearance; and determining an identity of the pharmaceutical substance in accordance with results of the comparing.

According to some examples of the presently described subject matter, the textual content includes at least one of a generic name of the pharmaceutical substance, and a brand name of the pharmaceutical substance.

According to some examples of the presently described subject matter, the textual content specifies an amount of the pharmaceutical substance contained in the container.

According to some examples of the presently described subject matter, the amount is specified by both a number and a unit indication.

According to some examples of the presently described subject matter, the textual content names a manufacturer of the pharmaceutical substance.

According to some examples of the presently described subject matter, each label template encodes the textual content as digital sequence of code points.

According to some examples of the presently described subject matter, the at least one indication of graphical appearance comprises image intensity values in the reference label region.

According to some examples of the presently described subject matter, the at least one indication of graphical appearance comprises a pixel map representation of the reference label region.

According to some examples of the presently described subject matter, the at least one indication of graphical appearance comprises an eigenvector for a set of eigenvalue features.

According to some examples of the presently described subject matter, the comparing includes determining label information used in the comparison, and the determining label information includes determining at least some textual content displayed in the image of the label, and determining an indication of graphical appearance in the image of the label.

According to some examples of the presently described subject matter, both the determined textual content and the determined indication of graphical appearance are derived from a same region of the image of the label.

According to some examples of the presently described subject matter, the determined textual content of the image of the label is determined using an OCR engine.

According to some examples of the presently described subject matter, the determined indication of graphical appearance comprises a pixel map selected from the image of the label.

According to some examples of the presently described subject matter, the determined indication of graphical appearance comprises an eigenvector calculated from the image of the label.

According to some examples of the presently described subject matter, the textual content of each label template is assigned in respective portions to each of a plurality of fields of the data of the label template, each field also comprising a field identity.

According to some examples of the presently described subject matter, each field is associated with a region of the reference label including its respective portion of textual content.

According to some examples of the presently described subject matter, each field is associated with a respective one of the at least one indications of graphical appearance, ad the respective indication of graphical appearance is indicative of graphical appearance in the associated region of the reference label.

According to some examples of the presently described subject matter, the field identities identify at least a field for a brand name of the pharmaceutical substance, a field for a generic name of the pharmaceutical substance, and a field for an amount of the pharmaceutical substance.

According to some examples of the presently described subject matter, the field identities identify a field for a name of a manufacturer of the pharmaceutical substance.

According to some examples of the presently described subject matter, the container is a vial.

According to an aspect of some examples of the presently described subject matter, the method comprises normalizing the at least one image for comparison with the one or more label templates, according to a three dimensional structure of the pharmaceutical substance container.

According to some examples of the presently described subject matter, the method comprises normalizing the at least one image for comparison with the one or more label templates, according to any one or more of focus quality, illumination level, image contrast, and image foreshortening.

According to some examples of the presently described subject matter, the comparing comprises identifying text in a region of the at least one image corresponding in position to a position of the textual content in the region of the reference label.

According to some examples of the presently described subject matter, the comparing comprises: determining that there is a partial mismatch in textual content between one of the one or more label templates, compared to textual content identified in the at least one image of the label, and determining that there is a sufficient correspondence of the at least one image of the label with one of the at least one indications of appearance in the region of reference label; and the determining the identity of the pharmaceutical substance assigns an identity associated with the one of the one or more label templates, despite the partial mismatch in textual content.

According to some examples of the presently described subject matter, the method comprises controlling an imager to image the at least one image of the label of the pharmaceutical substance container.

According to some examples of the presently described subject matter, the method comprises controlling a manipulator to manipulate the pharmaceutical substance container to display it to the imager while controlling the image or image the pharmaceutical substance container.

According to some examples of the presently described subject matter, the method comprises receiving the pharmaceutical substance container.

According to some examples of the presently described subject matter, the accessing one or more templates comprises accessing at least a first template, according to a tentative identity of the pharmaceutical substance, and at least a second template, according to a similarity of the second template to the first template.

According to some examples of the presently described subject matter, the similarity is determined according to a metric of Hamming distance between the first and second templates.

According to an aspect of some examples of the presently described subject matter, there is provided a system for pharmaceutical substance preparation, the system comprising a processor and memory, wherein the memory includes instructions which instruct the processor to: access at least one image of a label of a pharmaceutical substance container; access one or more label templates, the data of each label template including: textual content of a region of a reference label, and at least one indication of graphical appearance in the region of the reference label; compare the image to the one or more label templates, including comparison to both the textual content and the at least one indication of graphical appearance; and determine an identity of the pharmaceutical substance in accordance with results of the comparison.

According to some examples of the presently described subject matter, the system includes an imager and an image controller, and the memory includes instructions which instruct the processor to control an image controller to image the at least one image of the label.

According to some examples of the presently described subject matter, the system includes a manipulator, and the memory includes instructions which instruct the processor to control a manipulator to position the label to be imaged in the at least one image of the label.

According to some examples of the presently described subject matter, the memory includes instructions which instruct the processor to perform any of the variations on the method of identifying a pharmaceutical substance specified hereinabove. For method variations including controlling an imager, the system includes an imager controller, and optionally an imager. For method variations including controlling a manipulator, the system optionally includes the manipulator.

According to an aspect of some examples of the presently described subject matter, there is provided a method of registering a label template for use in identification of pharmaceutical substances, the method comprising: accessing at least one image of a reference label; identifying textual content in one or more regions of the at least one image; generating one or more respective indications of graphical appearance in the regions of the at least one image; and storing the textual content as a label template, associated by region with the respective indications of graphical appearance.

According to some examples of the presently described subject matter, the identifying textual content comprises performing optical character recognition (OCR) on the at least one image of the reference label.

According to some examples of the presently described subject matter, the one or more regions are regions in which textual content is identified by the performing OCR.

According to some examples of the presently described subject matter, the method comprises assigning the textual content in respective portions to each of a plurality of fields stored in the label template, each field also comprising a field identity.

According to some examples of the presently described subject matter, the assigning is performed in accordance with dictionaries of textual content patterns expected in the plurality of fields.

According to some examples of the presently described subject matter, the assigning is performed in accordance with heuristics applied automatically to the textual content, according to at least one of the textual content itself, graphical appearance of a region of the at least one image in which the textual content appears, and surrounding context of the region in the at least one image.

According to some examples of the presently described subject matter, the heuristics comprise a regular expression.

According to some examples of the presently described subject matter, the heuristics specify relative positioning of two or more of the portions of textual content.

According to some examples of the presently described subject matter, the heuristics specify a relative font face size for one or more of the portions of textual content.

According to some examples of the presently described subject matter, the at least one image of the reference label is an image of a container labeled with the reference label.

According to some examples of the presently described subject matter, the at least one image of the reference label is an example image from a regulatory database.

According to an aspect of some examples of the presently described subject matter, there is provided a system configured to register a label template for use in identification of pharmaceutical substances, the system comprising a processor and memory storing instructions, wherein the instructions instruct the processor to: access at least one image of a reference label; identify textual content in one or more regions of the at least one image; generate one or more respective indications of graphical appearance in the regions of the at least one image; and store the textual content as a label template, associated by region with the respective indications of graphical appearance.

According to some examples of the presently described subject matter, the memory includes instructions which instruct the processor to control the image controller to image the at least one image of the reference label.

According to some examples of the presently described subject matter, the memory includes instructions which instruct the processor to control the manipulator to position the reference label to be imaged in the at least one image of the label, while the reference label is affixed to a container.

According to some examples of the presently described subject matter, the memory includes instructions which instruct the processor to perform any of the variations on the method of registering a label template specified hereinabove.

According to an aspect of some examples of the presently described subject matter, there is provided a method of adjusting registered label templates for distinctness, the method comprising: accessing a first label template specifying a first set of features which, when matched, identify a label image as an instance of a first label type; accessing a second label template specifying a second set of features which, when matched, identify a label image as an instance of a second label type; determining that an estimated error distance between the first and second label templates is within a threshold for potential label template collision; and adding at least one specified feature to the first set of features, the at least one specified feature being selected to increase the estimated error distance.

According to some examples of the presently described subject matter, the error distance is estimated using a Hamming distance between textual content of the first and second label templates.

According to some examples of the presently described subject matter, the added at least one specified feature comprises a distinguishing color of the first and second label templates.

According to some examples of the presently described subject matter, the added at least one specified feature comprises a feature of a region of text distinguishing the first and second label templates.

According to some examples of the presently described subject matter, the feature of the region of text comprises one or more of textual content, a size of the region of text, an orientation of the region of text, and a size of glyphs in the region of text.

According to an aspect of some examples of the presently described subject matter, there is provided a system configured to adjust registered label templates for distinctness, the system comprising a processor and memory storing instructions, wherein the instructions instruct the processor to: access a first label template specifying a first set of features which, when matched, identify a label image as an instance of a first label type; access a second label template specifying a second set of features which, when matched, identify a label image as an instance of a second label type; determine that an estimated error distance between the first and second label templates is within a threshold for potential label template collision; and add at least one specified feature to the first set of features, the at least one specified feature being selected to increase the estimated error distance.

According to some examples of the presently described subject matter, the memory includes instructions which instruct the processor to perform any of the variations on the method of adjusting registered label templates specified hereinabove.

According to an aspect of some examples of the presently described subject matter, there is provided a method of confirming a uniquely valid match of a label image to a label template, the method comprising: determining that the label image corresponds to a first label template specifying a first set of features sufficiently to identify the imaged label as an instance of a first label type; selecting a second label template specifying a second set of features according to an estimated similarity of the second label template and the first label template; determining that correspondence of the label image with the second label template is within a threshold for potential label template collision; and raising an alert, in accordance with the determining.

According to some examples of the presently described subject matter, there is provided a system comprising a processor and memory storing instructions which instruct the processor to perform the method of confirming a uniquely valid match of a label image to a label template specified hereinabove.

Optionally, any suitable component of a system described in terms of a memory with instructions which instruct a processor may be implemented in processing circuitry as fixed circuitry elements; for example, using one or more application specific integrated circuits.

Optionally, any processing instructions and data elements described herein are provided on non-transitory computer readable media.

According to an aspect of some examples of the presently described subject matter, there is provided a processing circuitry-based method of ensuring safety of robotic pharmaceutical preparation, the method comprising: a) receiving an image of a label of a pharmaceutical substance container; b) classifying the received image, utilizing a trained machine learning model, to data indicative of pharmaceutical substance properties; c) performing optical character recognition (OCR) on the received image, thereby giving rise to OCR text data; and d) responsive to a positive correlation of the OCR text data with the pharmaceutical substance properties, utilizing contents of the pharmaceutical substance container in pharmaceutical preparation.

According to some examples of the presently described subject matter, the method additionally comprises: e) responsive to a negative correlation of the OCR text data with the pharmaceutical substance properties, raising an alert.

According to an aspect of some examples of the presently described subject matter, there is provided a system of ensuring safety of robotic pharmaceutical preparation, the employing a processing circuitry configured to: a) receive an image of a label of a pharmaceutical substance container; b) classify the received image, utilizing a trained machine learning model, to hereinabove. data indicative of pharmaceutical substance properties; c) perform optical character recognition (OCR) on the received image, thereby giving rise to OCR text data; and d) responsive to a positive correlation of the OCR text data with the pharmaceutical substance properties, utilize contents of the pharmaceutical substance container in pharmaceutical preparation.

According to an aspect of some examples of the presently described subject matter, there is provided a computer program product comprising a non-transitory computer readable storage medium retaining program instructions, which, when read by a processing circuitry, cause the processing circuitry to perform a computerized method of ensuring safety of robotic pharmaceutical preparation, the method comprising: a) receiving an image of a label of a pharmaceutical substance container; b) classifying the received image, utilizing a trained machine learning model, to data indicative of pharmaceutical substance properties; c) performing optical character recognition (OCR) on the received image, thereby giving rise to OCR text data; and d) responsive to a positive correlation of the OCR text data with the pharmaceutical substance properties, utilizing contents of the pharmaceutical substance container in pharmaceutical preparation.

According to an aspect of some examples of the presently described subject matter, there is provided a safety-enhanced pharmaceutical preparation device, comprising a processing circuitry (PC) configured to: a) obtain, using an identification device, data indicative of required contents of a pharmaceutical dose (PD); b) lock a receiving container of the PD into the pharmaceutical preparation device; c) initiate, using robotic capabilities, a pharmaceutical preparation sequence that is based on the required contents, to create the PD; d) responsive to, at least, successful completion of the pharmaceutical preparation sequence, perform, using a camera, an image scan of the created PD, thereby resulting in a PD image; and e) responsive to detecting, using imaging processing techniques, that the PD image depicts data indicative of the required contents of the PD, utilize robotic capabilities to unlock the PD from the pharmaceutical preparation device.

According to some examples of the presently described subject matter, the PC is further configured to obtain data indicative of the required contents of the PD by obtaining an identifier of the PD; and wherein the PC is further configured to, subsequent to a): transmit the identifier to a control server; and wherein the PC is configured to receive the data indicative of the required contents from the control server, the required contents being based on the identifier; and wherein the PC is further configured to, subsequent to d): transmit an indication of successful pharmaceutical preparation sequence completion to the control server; thereby avoiding a requirement of direct access by the pharmaceutical preparation device to electronic medical records (EMR) systems, and enabling privacy-protecting integration of pharmaceutical preparation with EMR systems.

According to some examples of the presently described subject matter, the data indicative of the required contents of the PD is a scan of a label comprising at least one of a group consisting of a barcode, a QR code, and an identifier text.

According to some examples of the presently described subject matter, the PC is configured to lock the receiving container before initiating the pharmaceutical preparation sequence.

According to some examples of the presently described subject matter, the PC is configured to lock the receiving container subsequent to initiating the pharmaceutical preparation sequence.

According to some examples of the presently described subject matter, the PC is configured to lock the receiving container responsive to an instruction from the control server.

According to an aspect of some examples of the presently described subject matter, a non-transitory computer readable medium is provided which stores a database of templates for identification of a pharmaceutical label, each template comprising a plurality of fields identified according to a type of information represented by the field, and each field associated with a text string representing text in a region of the pharmaceutical label, along with an indication of graphical appearance in the region.

Unless otherwise defined, all technical and/or scientific terms used herein have the same meaning as commonly understood by one of ordinary skill in the art to which the present disclosure pertains. Although methods and materials similar or equivalent to those described herein can be used in the practice or testing of embodiments of the present disclosure, exemplary methods and/or materials are described below. In case of conflict, the patent specification, including definitions, controls. In addition, the materials, methods, and examples are illustrative only and are not intended to be necessarily limiting.

As will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, microcode, etc.) or an embodiment combining software and hardware aspects that may all generally be referred to herein as a “circuit,” “module” or “system” (e.g., a method may be implemented using “computer circuitry”). Furthermore, some embodiments of the present disclosure may take the form of a computer program product embodied in one or more computer readable medium(s) having computer readable program code embodied thereon. Implementation of the method and/or system of some embodiments of the present disclosure can involve performing and/or completing selected tasks manually, automatically, or a combination thereof. Moreover, according to actual instrumentation and equipment of some embodiments of the method and/or system of the present disclosure, several selected tasks could be implemented by hardware, by software or by firmware and/or by a combination thereof, e.g., using an operating system.

For example, hardware for performing selected tasks according to some embodiments of the present disclosure could be implemented as a chip or a circuit. As software, selected tasks according to some embodiments of the present disclosure could be implemented as a plurality of software instructions being executed by a computer using any suitable operating system. In some embodiments of the present disclosure, one or more tasks performed in method and/or by system are performed by a data processor (also referred to herein as a “digital processor”, in reference to data processors which operate using groups of digital bits), such as a computing platform for executing a plurality of instructions. Instruction executing elements of the processor may comprise, for example, one or more microprocessor chips, ASICs, and/or FPGAs. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well. Any of these implementations are referred to herein more generally as instances of computer circuitry.

Any combination of one or more computer readable medium(s) may be utilized for some embodiments of the present disclosure. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. A computer readable storage medium may also contain or store information for use by such a program, for example, data structured in the way it is recorded by the computer readable storage medium so that a computer program can access it as, for example, one or more tables, lists, arrays, data trees, and/or another data structure. Herein a computer readable storage medium which records data in a form retrievable as groups of digital bits is also referred to as a digital memory. It should be understood that a computer readable storage medium, in some embodiments, is optionally also used as a computer writable storage medium, in the case of a computer readable storage medium which is not read-only in nature, and/or in a read-only state.

Herein, a data processor is said to be “configured” to perform data processing actions insofar as it is coupled to a computer readable medium to receive instructions and/or data therefrom, process them, and/or store processing results in the same or another computer readable medium. The processing performed (optionally on the data) is specified by the instructions, with the effect that the processor operates according to the instructions. The act of processing may be referred to additionally or alternatively by one or more other terms; for example: comparing, estimating, determining, calculating, identifying, associating, storing, analyzing, selecting, and/or transforming. For example, in some embodiments, a digital processor receives instructions and data from a digital memory, processes the data according to the instructions, and/or stores processing results in the digital memory. In some embodiments, “providing” processing results comprises one or more of transmitting, storing and/or presenting processing results. Presenting optionally comprises showing on a display, indicating by sound, printing on a printout, or otherwise giving results in a form accessible to human sensory capabilities.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present disclosure may be written in any combination of one or more programming languages, including an object-oriented programming language such as Java, Smalltalk, C++ or the like and conventional procedural programming languages, such as the “C” programming language or similar programming languages. Additionally or alternatively, sequences of logical operations (optionally logical operations corresponding to computer instructions) may be embedded in the design of an ASIC and/or in the configuration of an FPGA device. The program code may execute entirely on the user's computer, partly on the user's computer (e.g., as a stand-alone software package), partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present disclosure may be described below with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Some of the methods described herein are generally designed only for use by a computer; and may not be feasible or practical for performing purely manually, by a human expert. A human expert who wanted to manually perform similar tasks, such inspecting objects, might be expected to use completely different methods, e.g., making use of expert knowledge and/or the pattern recognition capabilities of the human brain, which would be vastly more efficient than manually going through the steps of the methods described herein.

### BRIEF DESCRIPTION OF THE SEVERAL VIEWS OF THE DRAWINGS

Some embodiments of the present disclosure are herein described, by way of example only, with reference to the accompanying drawings. With specific reference now to the drawings in detail, it is stressed that the particulars shown are by way of example, and for purposes of illustrative discussion of embodiments of the present disclosure. In this regard, the description taken with the drawings makes apparent to those skilled in the art how embodiments of the present disclosure may be practiced.

In the drawings:

FIG. 1A illustrates an example robotic pharmaceutical preparation system, in accordance with some examples of the presently disclosed subject matter;

FIG. 1B schematically illustrates an example of a pharmaceutical container label, according to some examples of the presently disclosed subject matter;

FIG. 2 is a flowchart illustrating a method of registering a label for use by a pharmaceutical preparation system, according to some examples of the presently disclosed subject matter;

FIG. 3 schematically illustrates elements assigned to fields of a structured template, according to some examples of the presently disclosed subject matter;

FIG. 4 is a flowchart of a method labeled container verification, according to some examples of the presently disclosed subject matter;

FIG. 5 is a flowchart of a method of label identification and/or verification, according to some examples of the presently disclosed subject matter;

FIG. 6 is a schematic flowchart of a method of adjusting registered label verification templates for distinctness, according to some examples of the presently disclosed subject matter;

FIG. 7 is a schematic flowchart of a method of detecting confusion risk during label template matching, in accordance with some examples of the presently disclosed subject matter;

FIG. 8 illustrates an example robotic injection preparation system employing machine-learning-based verification of pharmaceutical components, in accordance with some examples of the presently disclosed subject matter;

FIG. 9A illustrates an example pharmaceutical label utilizable in a robotic injection preparation system employing machine-learning-based verification of pharmaceutical components, in accordance with some examples of the presently disclosed subject matter;

FIG. 9B illustrates rotation of a container in front of a line-scanning camera, in accordance with some examples of the presently disclosed subject matter; and

FIG. 10 illustrates a flow diagram of an example method of machine-learning-based verification of pharmaceutical components, in accordance with some examples of the presently disclosed subject matter.

### DESCRIPTION OF SPECIFIC EMBODIMENTS OF THE DISCLOSURE

The presently disclosed subject matter, in some embodiments thereof, relates to the field of imaging in robotics, and more particularly, but not exclusively, to implementation of systems for specification and/or verification of robotic preparation of pharmaceutical doses.

### Overview

A broad aspect of some examples of the presently disclosed subject matter relates to the use of label image information in automatically identifying and/or verifying the identification of pharmaceutical substances. In some examples, the identification and/or verifying of pharmaceutical substances is performed in conjunction with the preparation of pharmaceutical preparations making use of the pharmaceutical substances; e.g., automatic preparation by a pharmaceutical preparation system.

Pharmaceutical preparation systems perform transfers of pharmaceutical substances among containers, including, e.g., withdrawal, injection, and/or mixing of substances from, to, and/or within containers. It should be understood that there is a need for careful verification of the activities and results of automatic pharmaceutical preparation systems, e.g., in view of risks associated with the administration of pharmaceuticals to patients. In particular, certain aspects of how information is passed along the pharmaceutical distribution chain have developed under the assumption of direct involvement in pharmaceutical preparation tasks by human technicians. In particular, information on labels of pharmaceutical containers may be structured to reduce confusion for human readers, without necessarily presenting fully equivalent information in a standardized form targeted at machine reading. For example, machine-readable identifiers (when present) often are numbers which reference needed information, but do not themselves describe it. This introduces dependencies potentially associated with risk. Additionally or alternatively, making use of human-readable information potentially comprises an important cross-check on machine readable information, and/or reduces a risk of confusion which could arise when a human operator relies on different label information than is used by the automated system they are supervising.

Insofar as automated systems substitute for human involvement, there is a potential need to provide those automated systems with capabilities to convert human-targeted information sources into machine representations of information. It is a potential advantage, moreover, that such capabilities be self-verifying, and/or susceptible to analysis of their reliability.

### Issues for Automatic Pharmaceutical Label Identification

Considerable effort is made by relevant regulatory bodies worldwide to ensure that pharmaceutical materials are clearly and completely labeled.

Standards can vary among different regulatory jurisdictions, however. Furthermore, pharmaceutical labels are generally not regular and standardized in every detail. As well as carrying many different pieces of information, they can be visually complex. Textual information can be provided in various typefaces, type sizes, and colors. Some information may be stylized (made partially decorative) in the form of a logo or other trademark indication. Information provided on a label may include both fixed text (e.g., names and substance amounts), and variable text (e.g., lot numbers and expiration dates). Text often is oriented in a plurality of directions (e.g., two or more of left-to-right, right-to-left, top-to-bottom, and/or bottom-to-top). Additionally, labeling may use manufacturer-selected coloring and/or patterning which visually distinguishes (e.g., according to dose amount) and/or groups (e.g., according to substance type and/or manufacturer) pharmaceutical containers. Variability of this sort poses potential problems for machine-based identification of pharmaceutical labels, particularly since the variability may be possible in future-designed label types (which, accordingly, need to be accommodated in a fairly general way).

Machine-targeted labeling indications such as bar codes and/or QR codes are often present, but their use is not universally standardized or mandated. Even when present, a machine-targeted labeling indication may provide incomplete information. For example, it may simply provide a compactly-written numerical indication uniquely assigned to a certain pharmaceutical manufacturer and formulation. Determining the pharmaceutical container's actual specifications based on this numerical indication may require further access to a database which indexes the numerical indication to information such as the manufacturer's actual name, the active ingredient of the pharmaceutical, and/or the contained dose amount. This potentially introduces an external dependency into identification of a labeled container's contents, even when the label itself actually provides all required dose information in other (human readable) forms. Reliance in automated systems solely on such machine-targeted labeling indications also introduces the potential, at least in principle, for skew between what a human handling the container would read, and what a machine handling the container would read.

Labels are potentially applied incorrectly (e.g., with bubbling, creasing, and/or incorrect orientation) and/or may include misprints. Labels may be subjected to damage during storage and/or handling which decreases their legibility.

Potentially compounding these issues (at least for automatic label identification), the labels for two pharmaceutical containers are sometimes very similar in nearly all of their characteristics, even though they are different in a critical factor such as the overall amount of pharmaceutical substance which the container holds. In textual content, for example, a difference as small as a single digit of a number or a single character of a unit designation could be critical in distinguishing a safe dose from an unsafe dose. Similarly, different dose amounts of the same substance from the same manufacturer may be distinct in just one or two digits of a machine-targeted identifying code.

Furthermore, the three-dimensional shape of a container to which a label is applied (e.g., a cylindrical shape) may lead to the result that no single imaging viewpoint onto the label clearly contains all needed information for automatic container identification.

Although manufacturers may attempt to reduce label confusion risk for human readers by techniques such as different typographical arrangements of supporting text, different use of color, different patterning, and/or different overall package sizes and/or shapes, what may be casually and intuitively obvious to a human is not necessarily among the cues which an automatic system is configured to make use of.

### Structured Templates for Label Identification

In some examples of the presently disclosed subject matter, at least some of these problems are mitigated by the creation and/or use of structured templates to identify the labels of pharmaceutical substance containers such as vials.

### Complementary Specifications of Label Content

An aspect of some examples of the presently disclosed subject matter relates to the creation and/or use of structured templates including complementary specifications of label content for one or more regions: both textual content, and some additional representation or method of assessing the graphical appearance associated with that textual content (distinct from the text's sequence of identified characters as such). Examples of complementarily specified data in a structured template are described, for example, in relation to FIG. 3.

Structured templates are also referred to herein as “label templates”. Structured templates are constructed with respect to one or more reference labels. A reference label may be from actual instance of a labelled container. A reference label may be provided separately from a specific container (e.g., as a flat, still unused sticker). A reference label may be and/or be derived from a digital representation and/or specification of the label; e.g., an image file. Optionally, information from a plurality of reference labels and/or reference label images is combined to generate a structured template.

Textual content may be understood as label information conveyed using character glyphs, separate from geometrical particulars of the glyphs actually used. In particular, textual content is equivalently representable in different digital forms. For example, textual content is optionally represented as a sequence of character code points; e.g., character code points as specified by Unicode, ASCII, or another text encoding standard. If compression is applied to a digital representation of textual content, the compression is reversible to recover character code points in the same sequence as before compression.

Label information which remains is assigned to the category of graphical appearance. In a structured template, this is optionally indicated by a representation of intensity values in an example image of the label, and/or a portion thereof, for example, intensity values of an array of pixels, and/or intensity values associated with one or more geometrically specified shapes. In a structured template, graphical appearance of a label region is not necessarily represented with fully recoverable fidelity. For example, a lossy compression method may be applied to data which represents graphical appearance as an image.

In some examples, graphical appearance is indicated, but not necessarily represented (however, graphical appearance representation is considered a type of indication). For example, graphical appearance may be indicated statistically, e.g., as a histogram of intensity values in a region. In another example, a hashing or vectorization algorithm may be used which is expected to reach a same or similar numerical result for image regions which are “sufficiently similar” under some relevant metric, but does not contain sufficient information to allow the image region itself to be reconstructed, and potentially does not even represent intensity values. Some examples making use of machine learning products (e.g., sets of learned weights for a neural network) for graphical appearance evaluation may be considered as “indicating”, e.g., insofar as their results indicate which label type a certain label instance belongs to, rather than representing the label appearance as such. In other uses of machine learning products, a vectorization may be reversible into some kind of graphical representation, e.g., using it as an eigenvector for a set of eigenvalue “features”.

The combination of two specification and identification methods mitigates risk when at least one of them is occasionally erroneous. In the preparation of pharmaceuticals, the risk of error may be considered a critical risk, since misidentification of a substance and/or substance amount could lead to patient harm. Conversely, however, a requirement for absolute certainty from a single method of label identification may not be technically achievable. The single method may be error prone and/or probabilistic, for example. Additionally or alternatively, reliance on absolute validity of an individual method may be considered unacceptable from the perspective of a risk analysis. For example, a method may be considered vulnerable to systematic risks imposed by the context in which is is applied (e.g., database errors or unusual illumination conditions), even if the method itself is ordinarily “perfect” in assessing matches as such.

Relating to textual content in particular: while (irreversible) hashing algorithms are optionally used as part of the manipulation of textual content representations, it is a potential advantage for structured templates to include a direct or unambiguously recoverable representation of a labeled region's sequence of character code points, as explained above.

This constraint helps to preserve individual label instances as self-contained indications naming their contents, even in the case of automated label identification. This property of being “self-contained” corresponds to the sense in which the labels are also self-contained indications understandable by human individuals who read them. Specifically, names and amounts are directly represented, rather than indicated merely indirectly and by reference, such as by an assigned reference number for such information. It should be understood that “self-contained” in this sense is directed at the information which is ordinarily learned from reading the label, and does not require that the indication conveys the weight of ordinary conventions such as the background conventions of language and linguistic representation assumed to be accessible by a human reader of the label.

Relating next to the contribution of graphical appearance representations: although modern optical character recognition (OCR) is generally excellent at identifying text present in an image, character mis-identification is enough of a possibility that it is preferably taken into account as a risk for an automated label-identifying system. Mis-identification of characters can happen, for example, when a typeface (especially a stylized typeface such as may be present in the name of a brand or manufacturer) has an unusual glyph form and/or positioning of glyphs, when a character sequence is unusual, and/or simply due to imaging conditions such as focus quality and imaging noise.

In some examples of the presently disclosed subject matter, accordingly, graphical appearance is used for correcting errors in textual content identification, and/or verifying textual content which has been correctly identified. With respect to a certain label instance matching a certain label template, one or both of false positive matching (incorrect matching to a label template) and false negative matching (incorrect failure to match a label template) may be addressed.

It is a potential advantage, for example, that automated identification be robust to OCR errors, approximately to the extent that when a label is clear and correct for a human reader, it is also correctly recognized as acceptable for use by the automated system. It may not be acceptable to reject a substance container from use in preparing a medication, e.g., just because of a single character error in text identification, especially if this error is an artifact of OCR engine limitations. At the same time, it is preferable that the automated system is not over-accepting of errors.

Considering a complementary category of automatic label identification implementations for which textual content identification (e.g., OCR) is omitted: label matching based solely on, e.g., a form of (non-textual) pixel pattern matching may also be considered to carry risk. Depending on the method used, risk may be, for example, due to an inherently probabilistic nature of the method, and/or due to the use by the method of threshold-based parameters, where the threshold setting is somewhat arbitrary.

There is also a potential risk insofar as reliance on graphical appearance alone omits the actual determination of the “self-contained” information that the label carries for an ordinary human reader. Risk arises, for example, in the possibility that the matched template has been mis-identified in the database (leading to mistakes a human seeing the label would not make), or that subtle label tampering could “fool” an automated system into mis-categorizing it, while a human user only notices ordinary textual content. With an OCR-based method, textual content of a label and the identification of the label are closely linked, so that risk of skew of this particular type is reduced.

### Field-Identified Structuring of Label Content

An aspect of some examples of the presently disclosed subject matter relates to the creation and/or use of structured templates which assign each of plurality of specific regions of a label a respective field identity specifying the meaning of the data which it describes. The field identity is, for example, one of “brand name”, “generic name”, “substance amount”, or “manufacturer”. However, field identity is not necessarily given by a field's name (if it has one); e.g., fields can be given arbitrary identifier strings, numbered, and/or stored in a predetermined order.

Region locations may be identified by any suitable data. For example, rectangular region locations may be identified by horizontal and vertical offsets from label boundaries, along with horizontal and vertical extents. Non-rectangular regions are not excluded. In some preferred examples, structured templates limit the positions where the information of a field can occur. This provides a potential advantage by reducing likelihood of accidental resemblances of different labels. It is noted that OCR engines typically include a module which performs the task of identifying text-containing regions. The identified text, accordingly, is associated with a particular region upon its origination.

Field values are not necessarily textual. Optionally, graphical appearance is assessed for one or more non-textual features of the label, such as logo shape and/or background color. In some examples, features of a container's construction distinct from the label itself are incorporated into a structured template. For example, the container's size and/or shape may be considered as describing field values. In some examples, container size and/or shape are referenced in the structured template in order to assist in the geometrical normalization of a label. For example, a label which wraps around a cylindrically shaped portion of a vial may have regions which appear foreshortened, out-of-focus, and/or out of scale. Optionally, information about the container shape to which the label has been applied is used to help determine which parts of the label image are valid for analysis, and/or how label image portions should be transformed (e.g., during a pre-processing stage) in order to use them in structured template matching.

While the value of a field is often conveyed by the image of a particular region of a label, a field's value may in some cases be a global feature of the label; for example, its dimensions and/or shape. The label regions associated with different fields are not necessarily mutually exclusive; e.g., a same region's color and textual content may be associated with different respective fields. Palimpsest text (two texts overlapping each other) is not excluded either. While labels designed for clarity will generally avoid self-overlapping text, certain imaging conditions (e.g., transillumination of a glass vial) may result in show-through of one label part to another label part. In another palimpsest-like example, partially transparent or translucent labels might be applied to overlap one another.

Optionally, textual content and/or graphical appearance is assessed for text which is otherwise insignificant and/or secondary to the requirements of identification as such; e.g., text which indicates storage and/or handling information which is not of particular significance for identification purposes, but may nonetheless be distinguishing in its specific wording and/or graphical appearance. In some examples, this text may include a repetition of information available in one of the fields which is significant, and optionally this repetition is identified and incorporated into the procedure for template matching (e.g., consistency of two matching pieces of information is optionally verified).

### Optical Character Recognition of Label Information

In some examples, textual content (e.g., of a field's value) is determined using optical character recognition (OCR) techniques, e.g., using an OCR library previously known in the art such as Tesseract or EasyOCR.

As noted above, typical output of an OCR subroutine indicates both where text is found present in an image, as well as what that text has been determined to be (which characters it contains, and in what order). In some examples, three-dimensional label geometry (label shape once applied to a container) is used to assist in transforming images into a form suitable for OCR.

In some examples, text in a label is freely identified by an OCR engine, including free identification of text position. In some examples, data stored in the available structured templates is used to constrain where text may be searched for, and/or what type of text may be seen in certain location. In some examples, free-position OCR and position-constrained OCR are mixed; e.g., position-constrained OCR is used to restrict template comparisons to likely matches, but free-position OCR is used to avoid placing excessive constraints on the analysis of the actual label under inspections, which might interfere with match determination.

Additionally or alternatively, in some examples, a first stage of an OCR algorithm may be run which merely identifies where (e.g., where, relative to label edges or other landmarks) text can be seen on a label, without identifying the text itself. This in turn may be used to select a plausible subset of structured templates against which detailed matching is attempted.

To help reduce the number of comparisons calculated, selection of structured template(s) for comparison is optionally based on previous (recent) results and/or the structured template which is expected to match. Optionally, structured templates which are considered similar to recently matched templates are also included. This has a potential advantage, e.g., by helping to avoid overcommitment to such expectations and/or historical results. Optionally, structured template searching is broadened when expected template matching is weak (e.g., below a certain threshold of scoring).

Textual content (at least when it is correct), directly indicates information which is important to the use of the pharmaceutical substance. For a correct match, an exact match to the textual description of a requirement is likely and preferred, but not necessarily required.

If textual content is somehow correct in the label itself, but mistakenly identified by OCR, it may be sufficient to simply not use the pharmaceutical substance out of an abundance of caution. Mistaken discarding, though potentially producing inefficiency, is optionally corrected by a human operator.

To potentially reduce such inefficiencies, there may be certain types of misidentification typical of OCR which are treated as being within acceptable tolerances; for example, substitution of “1” for 1” or “O” for “0”, when everything else is correctly identified, and/or when this has been previously approved by a human supervising operations. In certain cases (e.g., when the textual content is stylized, and/or uses an unusual typeface), the level of allowable OCR error (e.g., number of errors and/or list of permissible but erroneous character substitutions) is optionally increased. Discussion of error tolerance is further described below.

Potentially the greatest risk to patients is that an incorrectly identified (e.g., OCR-identified) string of text characters should turn out to mimic the expected text characters, so that the mistakenly placed pharmaceutical container is accepted for use, when it should not be. The likelihood of this is somewhat reduced by region restrictions on field values. However, risk assessment may still be required to consider cases where containers differ critically in the dose amount that they contain, but share a same layout of their fields (e.g., they share a manufacturer, brand name and generic substance name, all positioned in the same regions of their labels).

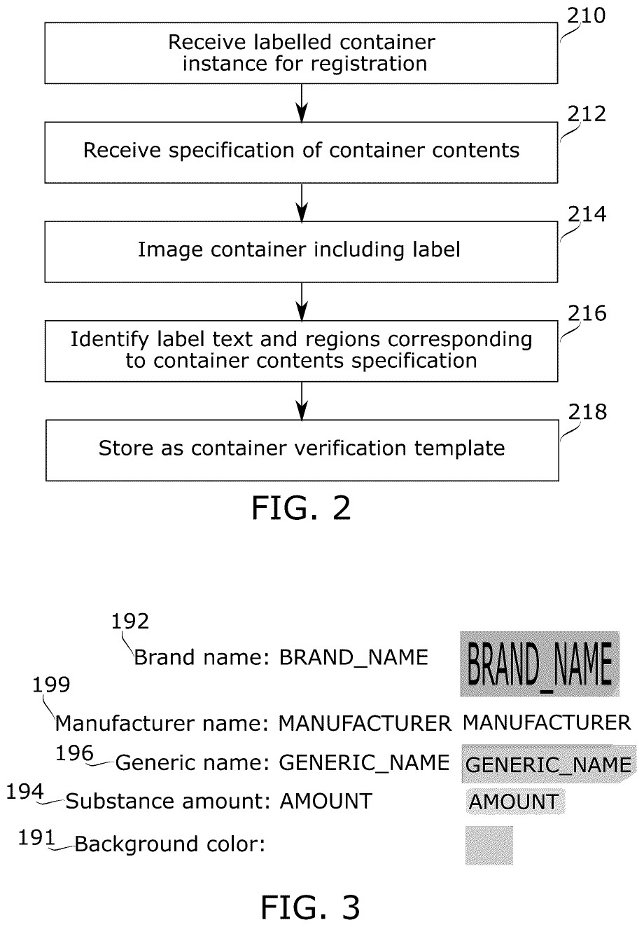

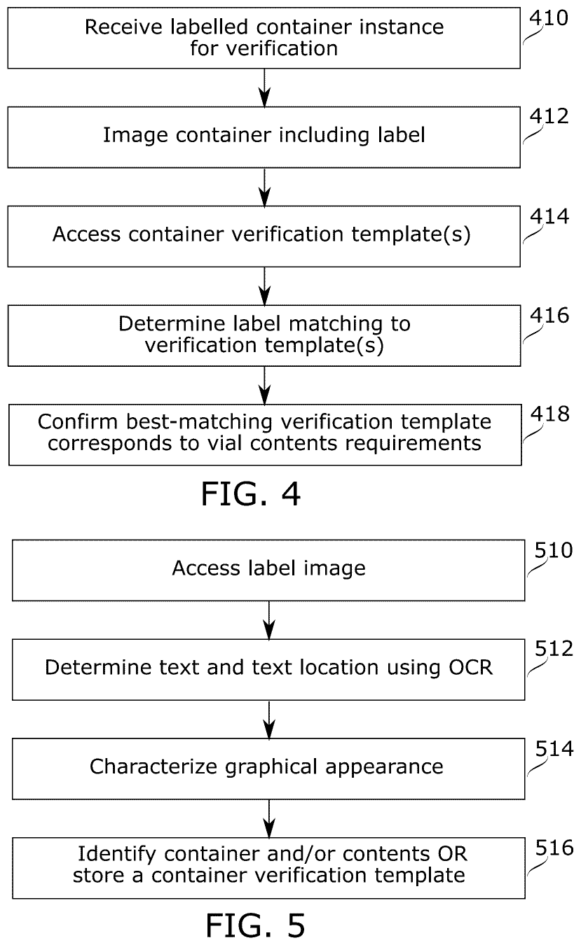

Use and/or implementation of OCR and/or textual content identification more generally is also discussed, for example, in relation to block 416 of FIG. 4, block 512 of FIG. 5, and block 216 of FIG. 2.

### Graphical Appearance-Based Validation of Label Information

For mitigating label identification risk, there are potential synergies in the hybrid use of graphical appearance together with textual content (e.g., as identified using OCR). Graphical appearance within an identified text region can be characterized in one or more of several respects. Examples include: the size of this region; size, spacing and/or typeface of the recognized letter forms; and/or the arrangement of pixel values within the same text regions of the image. Optionally, graphical appearance is further transformed and/or measured for storage in the structured template of a label; e.g., compressed, converted into outlines, thresholded, assessed for color distribution (histogram), or otherwise subjected to image transformation and/or analysis. As mentioned above, graphical appearance may be at least partially represented (e.g., as geometrically structured features and/or intensities), or simply indicated with an indicator (e.g., a hash value) that other indicators can be compared with.

As for textual content, information about the three-dimensional shape of the label as applied to a container may be used to generate appropriate geometrical transformations for use in image comparisons with structured templates. Geometrical transformation potentially allows comparison of label image regions even when taken from different angles, e.g., with different rotation of a label wrapped around a round vial relative to an imager (e.g., an optical imaging camera). The transformation may be deterministically chosen (e.g., based on template-recorded knowledge of the container shape), or it may be chosen (e.g., chosen by an iterative error minimizing process) to optimize image similarity to the template. Optionally, the geometrical transformation is selected to be “global” (e.g., with relatively few parameters) so that flaws in the appearance of a label will not be factored out by parameters of the transformation.

Optionally, when identifying and/or verifying the identity of a pharmaceutical substance label, any one or more of several different approaches may be used as the basis of a second criterion using graphical appearance to supplement textual content.

In some examples, a structured template contains a pixel map of a text-containing region. When used in label identification, it may be required not only that the identified textual content of a label sufficiently match text specified by the template, but also that a pixel map of the text's region correspond with the template's pixel map (e.g., match according to some analysis metric, optionally within some tolerance). This potentially would detect cases where text is misidentified due to a label deformation such as a crease in the label—the deformation would affect the relative positioning of text characters, such that the overall graphical appearance of the region would be prevented from matching. Conversely (e.g., to mitigate OCR false negatives), errors in OCR-identified text could optionally be overcome by a sufficiently close match based on pixel map value comparison.

Another approach (additional with or alternative the above) uses metrics derived from the process of identifying textual content. These can include, for example, the extent of the text overall, and/or the locations of individual characters.

Another approach includes examples using differential imaging (image subtraction and/or division), optionally after suitable normalization to account for differences in, e.g., focus, illumination level, and/or image contrast. The standard of comparison can be “zero difference”, with some tolerance for noise, e.g., a tolerance set based on calculations, and/or on trial images with and/or without flaws in the label image. Optionally differences in different sub-regions are expected to be similar in magnitude, and if not that is optionally flagged as an indication of mismatch. For example, one misplaced letter may cause a sub-region to “stand out” with higher error than other letters, potentially distinct from character identifications which OCR may assign to a region.

In another approach, geometrical transformation to minimize differences between a template image region and an imaged label region is allowed to make any local or global shifts needed. Then the transformation itself is inspected to determine if it includes indications of a flaw in the label such as the introduction of discontinuities not seen in the template image region.

In some examples, machine learning is used to help identify non-textual features of labels. For example: for each label which is to be distinguished by a system, one or more training examples are created; e.g., images of the label as seen from one or more rotational directions, optionally with actually and/or synthetically generated label flaws. In some examples, training is broadened to use actual and optionally synthetically generated labels constructed from a large database of typical examples (e.g., examples as available from a regulatory database of labels). Variable regions (e.g., regions giving lot number and/or expiration date) are optionally excluded, and/or such regions are generated to also be variable in the training data set.

Machine learning, in some examples, receives feedback according to whether or not it correctly categorizes a label to a certain label type; e.g., whether or not it correctly assigns different views of a certain label example to the same label category. Additionally or alternatively, machine learning reinforcement is based on the categorization of features in the label; for example critical characteristics such as manufacturer, brand name, generic name, and/or contents amount. Optionally, training is tiered, e.g., it includes training to distinguish “critical areas” of labels (areas giving information directly salient to identification) from “non-critical areas” of labels. Subsequent training focused on identification itself potentially benefits from this restriction of which areas of the label are salient to identification of the pharmaceutical contents which the label describes.

Use and/or implementation of graphical appearance comparisons in label identification and/or verification is also discussed, for example, in relation to block 416 of FIG. 4, and block 514 of FIG. 5.

### Assessment of Mis-Identification Risk

An aspect of some examples of the presently disclosed subject matter relates to the assessment of mis-identification risk of labels of pharmaceutical substance containers.

For automatic label identification and/or validation methods involving thresholds and/or potential borderline cases, there may be a concern with determining associated risk. For example, it is potentially valuable to be able to judge a level of risk of a false positive or false negative result, and/or provide a method of selecting algorithm parameters so that risk is kept at an acceptable level.

Although it is susceptible to producing errors, a potentially useful feature of OCR recognition is that its errors are inherently “countable”. This has potential advantages for producing Hamming distance metrics (and/or similar metrics), in which the “closeness” (i.e., the distance or similarity) of a label image to a structured template can be judged based on how many character changes are needed to make them match exactly. Optionally, errors can be weighted to indicate more- and less-significant substitution errors; for example, a substitution of “o” for “0” might be weighted as adding less “distance” than a substitution of “W” for “q”, since the glyph shapes are more similar, and/or because the correct value may be more easily guessed, given knowledge that a mistake has occurred. Additionally or alternatively, actual substitution error examples and/or error rates may be observed and used to score error significance.

Particularly since there are relatively few characters on a label, Hamming distances between strings of text (character sequences) can be calculated very quickly. This is optionally used to reduce the number of image-to-image comparisons which are made overall as a part of image verification, by only comparing label images with structured templates having fields with similar text values. Even substantially universal comparisons may be feasible; e.g., comparison to every known label of pharmaceutical substances registered in a jurisdiction, or comparison to every known label within a certain broad category such as packaging type and/or manufacturer.

In some examples of the presently disclosed subject matter, distance calculation is used to determine where and/or how much OCR error is allowable in matching a particular label to a structured template. Where the structured template database is accepted as covering substantially the whole domain of possible labels, it may be acceptable to increase the error count in a given text field (e.g., “manufacturer”), so long as this does not result in any likelihood of a mistaken cross-identification. It should be noted that the domain of label alternatives that needs to be considered for a certain field can potentially be shrunk considerably if high-quality matches are produced for other fields. For example, it may be possible to restrict consideration of error distance to just the substance amounts known to be packaged by a given manufacturer, so long as the manufacturer has been confidently identified. In some examples, the vocabulary available to an OCR engine for identifying text in a first field is selected (e.g., restricted) based on the reasonable options available in view of text values determined for one or more of the other fields of a structured template.

Hamming distances are optionally used for determining a risk of misidentification (and/or relative lack thereof). Cases where two labels (that is, their respective structured templates) in a database are very similar to each other in their text, and/or about equally similar to the example of a particular label, are optionally considered as indicative of a risk of confusion.

In the former case, mitigations are optionally introduced as part of registration, so that a larger number of differentiating features will be used later on as part of structured template matching. For example, label color in some sub-region of a label may be introduced as a differentiating factor, even if it is normally not explicitly considered and/or required.

In the latter case, mitigation may take the form of raising an alert for human intervention even though a good match has been found, since it may not be certain if the good match is genuine, or if a small number of mistakes in label identification has resulted in a spurious match. Additionally or alternatively, cases of “close matches” in the OCR space (e.g., small Hamming distances in text values) optionally result in greater weight being placed on non-OCR aspects of structured template matching, such as image analysis-based methods, and/or categorization by a machine learning product.

It should be noted that “distance” assessment is not restricted to Hamming distance, and not restricted to use with text information. For example, an image of a label (the whole label, or any suitable portion thereof) is optionally “vectorized” as a histogram of its pixel values (each value of the histogram providing a dimension), suitably normalized. Vector distances can then readily be calculated between two such histograms, and used as a basis for assessing similarity of an imaged label with a structured template.

In some examples, machine learning is used to create a “label vector space”; that is, a logical space of (machine-learning distinguished) label features into which a given label image (optionally including associated OCR-recognized text) can be encoded as a vector. Individual label images can then be compared to the encoded vectors of structured templates to determine which such vector(s) they are most similar to. As described for Hamming distances, there is also a potential advantage for detecting ambiguous cases. It is noted that machine learning may spontaneously incorporate relevant non-textual features (e.g., distinctive use of color and/or pattern in otherwise closely related labels) as part of the development of vector spaces which adequately distinguish among the examples of the training set.

However, it is also noted that validation of machine-learning products themselves (e.g., validating that they do not produce false indications during use, or even determining how likely it is that this could occur) is potentially a difficult task. For a designed algorithm, in contrast, it is potentially easier to reason about risk levels. Accordingly, the ability to convincingly demonstrate that risk level is calculable (e.g., as opposed to merely observable in testing results which may or may not completely reflect use conditions) is optionally a consideration in selecting the particular design of an automatic identifying and/or verifying system for pharmaceutical container labels.

### Registration of Structured Templates

An aspect of some examples of the presently disclosed subject matter relates to the registration of labels of pharmaceutical substance containers into a database of structured templates of such labels.

The process of creating a structured template for a label (and/or label plus container) is referred to herein as “template registration” (that is, registering a structured template descriptive of a label for use by a pharmaceutical preparation system). Herein, a method of registration of a structured template is described, for example, in relation to FIG. 2.

Data on a pharmaceutical container's label is not necessarily arranged according to a scheme which is either fully self-descriptive, or fully constrained by convention and/or regulatory requirements. Template registration optionally occurs with any suitable combination of automated and manually performed or assisted processes.

Optionally, in some examples, the field identification of a textual region of a label (its “meaning”) is assigned by the intervention of a human operator responsible for registering a certain label for use by a label-recognizing system. In some preferred examples, the human operator is presented with automatically identified label information (e.g., OCR results), and presented with user interface options to annotate and/or correct these results as appropriate.

For example, the human operator is provided with a user interface configured to allow indicating where on a label (e.g., together with which OCR-identified text) a field with a certain identification occurs. Optionally, the operator corrects and/or actually provides text values from the label.

In some examples, field identifications are automatically assigned (with or without subsequent human operator correction and/or confirmation via a user interface) according to heuristics applied to one or both of textual content and the graphical appearance, position and/or context of that textual content.

It should be understood that the application of heuristics can be structured in any suitable fashion. For example, several heuristics may be evaluated, and these results may contribute together to an identification. In anther example, a heuristic may be dominant when it “matches” certain text, but otherwise considered indeterminate, with the result that other heuristic evaluations are then consulted.

In some examples, the appropriate field identification of textual content is determined by making use of field-restricted vocabularies—e.g., vocabularies constructed using manufacturer names, brand names, and/or generic substance names. Matches within the vocabulary assigned to a particular field identification are interpreted as indications that the textual content is a value for that field identification.

Additionally or alternatively, heuristics for text content as such may compactly be described as regular expressions. For example, the regular expression:

$$[ 1 - 9 ] [ 0 - 9 ] + * ( [ m μ ] ? g \vert gram ) [ * ] ? \text{(*} ( per \vert / ) * ( vial \vert container ) ) ?$$

may be roughly described in natural language as ‘an integer in units of grams, milligrams, or micrograms (optionally followed by an asterisk); optionally followed by “per vial”, “per container”, “/vial” or “/container”; with optional space separators’. To allow for OCR errors, common mistakes may be included explicitly (e.g., allowing o or O in place of 0; allowing 1 in place of 1). Some regular expression languages allow specifying the number and/or type of individual character identification errors as part of the regular expression itself.

As examples of heuristics not based on textual values as such: a text such as “500 mg” somewhere on a label may indicate what is potentially the actual amount of a vial's contents—but there may be other number-and-unit indications on the label. Heuristics which optionally increase the likelihood assessment that the “500 mg” refers to an amount of the vial's contents could include, for example: having a relatively large typeface size, and/or having relatively greater proximity and/or similarity in orientation to text giving the brand name and/or generic name of the substance.

Particularly (but not exclusively) when textual contents of two different structured templates are similar, additional heuristics and/or operations may be applied to attempt to identify distinguishing characteristics. For example, colors used in association with text may be considered distinguishing. In another example, regions of text outside of those associated with specific fields may be subjected to OCR, or simply identified and assessed for their size, position, and/or shape. Additionally or alternatively, graphical appearance (distinct from textual content) is evaluated for such regions, or for any other region of the label.

In some examples, structured templates are registered based entirely on automatic procedures; for example, registered based on label images obtained from a regulatory database of such labels. Such structured templates are potentially useful for determination of a risk of accidental collision with fully registered templates (e.g., those which have been vetted and/or corrected by a human user), even if not treated as fully trusted themselves for identifying a substance container. For example, after a new label is registered by a user, a system may determine that the new label's structured template is sufficiently close to an automatically registered label (optionally not yet vetted) that there is a risk of collision. The system may then present that automatically registered structured template to the user for any additional confirmations and/or corrections; potentially including the definition of further distinguishing fields to reduce the chance of misidentification. Optionally, the system applies heuristics to automatically create distinguishing field information for one or both of the structured templates.

In another example, new registration information (e.g., a human user's corrections for one label's structured template) is optionally applied to related labels. That the labels are “related” may be determined based, e.g., on image and/or textual content similarities. For example, two or more labels may share the same manufacturer, but remain partially registered after automatic registration due to difficulty in identifying the manufacturer's name from stylized text. Once a user provides the manufacturer's name (for which a corresponding image region is available) for one of the labels, the system then has information which can be used to identify the same pixel pattern in other labels, and associate it with that same manufacturer's name. This is optionally performed automatically; or partially automatically with, e.g., user confirmation and/or corrective inputs.

### Definitions

Subject matter of the present disclosure generally relates to robotic pharmaceutical preparation systems, and more particularly to fluid transfer stations within a robotic pharmaceutical preparation system. It is to be understood that, for brevity and clarity, examples described herein (with reference to the drawings and otherwise) are described with reference to component subsets of pharmaceutical preparation systems; e.g., particular aspects of the overall fluid transfer apparatus assembly. Furthermore, examples straightforwardly analogous to examples described herein should be understood as being encompassed within the scope of the present disclosure. This includes, for example, particular implementations and/or combinations of elements and/or subsystems different in detail than explicitly described, but alike in function and/or functional role.

Pharmaceutical preparation systems: Embodiments of robotic pharmaceutical preparation systems and the fluid transfer stations thereof described herein are configured for performing operations related to transfer of pharmaceuticals between different fluid transfer apparatuses.

Robotic pharmaceutical preparation systems (which may alternatively be referred to as “robotic systems”) according with the subject matter of the present disclosure include elements and/or subsystems such as robotic stations, robotic arms, motors, control units, and/or other mechanisms which operate to perform, control, and/or verify fluid transfer. These elements are optionally designed and/or described as making up and/or made up of units and/or subsystems operable for performing activities related to preparation of pharmaceuticals designated for administration to patients. For example, a robotic system may comprise one or more automatic or partially automatic subsystems comprising at least one manipulator controlled at least partially by a controller unit (equivalently referred to as controller or control unit). Controller units may themselves be arranged in communication with each other, e.g., hierarchically, and/or in a network, in order to coordinate overall functioning of the pharmaceutical preparation system.

Pharmaceutical preparation system described herein perform fluid transfer between fluid transfer apparatuses designated containers and fluid transfer units, with the latter often acting as the intermediate element (typically but not necessarily also the “active” element, e.g., the element through which pressure is generated which results in fluid movement), and the former being considered as the fluid source or fluid receiving element (typically but not necessarily a “passive” element). The fluid transfer may be assisted by a fluid transfer connector. However, an ordinarily intermediate fluid transfer unit may nevertheless optionally operate as an initial source of a fluid (e.g., in the form of a pre-filled syringe provided at the beginning of pharmaceutical preparation), and/or as a final receptacle for fluid (e.g., in the form of a filled unit which passes onward to another process such as delivery to a patient, storage, or another purpose). Nor is it excluded that a container takes on an intermediate role as both a fluid source and as a fluid receiver.

Embodiments of transfer apparatuses may comprise, for example, one or more conduits, pumps, syringes, vials, intravenous bags, adaptors, and/or needles. Optionally, these elements are consumables and/or accessories of the pharmaceutical preparation systems. Optionally, such elements are nevertheless considered as pharmaceutical preparation system components. The term vial in particular is used herein as a term for containers in which contents beginning in a solid and/or relatively concentrated form are initially dissolved and/or diluted. In other examples, a vial contains an amount of fluid whether or not it was originally a container for a solid and/or concentrate. In other examples, the vial may still retain a substance in its solid and/or concentrated form. However, the term vial is not limited to this list of example cases.

Fluid: As referred to herein, “fluid” typically comprises a pharmaceutical, a diluent, saline solution, water, or any other fluid used in pharmaceutical preparation. Fluids may be understood more specifically to be provided as liquids, although the use of gaseous fluids is not excluded, insofar as their characteristics are consistent with descriptions herein.

Fluid transfer: “Fluid transfer” is performed in between a container assembly and a fluid transfer assembly via openings formed in a port of the container assembly or fluid transfer assembly and/or via openings formed in a septum of the container assembly or fluid transfer assembly.

Septum: Herein, a “septum” generally refers to a membrane configured to close access to a part of a device to which it belongs. A septum on a container or container connector (also referred to as container-septum) may seal the container. A septum on a fluid transfer assembly (also referred to as fluid transfer connector septum) may prevent or resist access to and/or by a fluid transfer conduit. Typically, a septum is made of a resilient pierceable material. Such material may be a polymer with elastic properties like rubber. A vial, for example, is often provided with a cap having an integrated septum.

Container: In performing fluid transfers, robotic systems operating in accordance with the present disclosure optionally manipulate, and/or inspect variously embodied containers. A “container” as described herein optionally refers to any one or more of: syringes, IV bags, elastomeric pumps, vials, bottles, ampules, syringes, conduits, pipes, or generally any vessel or receptacle suitable for holding fluids or liquids. It is further to be understood that the container can be any other element functioning as a component of a fluid transfer apparatus, with or without a connector (or “adaptor”) for establishing fluid communication of the container with other fluid transfer components. For example, the container can be a vial along with a vial adaptor, or an intravenous bag along with a spike adaptor. The container can be accessible via a container septum which can be a septum of the container lid or can be a part of the connector. In a process of fluid transfer performed using fluid pressure changes and/or differentials, a container characteristically experiences transfer of fluid due to a pressure change generated in and/or via a fluid transfer assembly with which it is connected.

Vial: As referred to herein, a “vial” (e.g., referring to a certain container) may include a closable vessel, formed for example of glass or plastic, such as an ampule or bottle, and containing a pharmaceutical in liquid or powder form. The vial can be a single or multiple use vial. The vial can be tubular or bottle shaped, having a neck portion in proximity to the vial opening. The vial can be topped with a cap, e.g., a cap with a septum. Vials are typically fixed in shape, and in particular fixed with a constant internal volume, although the volume may be filled to a greater or lesser extent. Vials, in some examples, are also preparatory vessels, in which the substances they supply are dissolved, diluted and/or reconstituted in preparation for further operations such as transfer into a syringe. Accordingly, operations performed on a vial commonly include one or both of injecting fluid and removing fluid. In between, there may be mixing operations which dissolve and/or dilute an originally contained substance with injected fluid. Vials are often supplied for use in manual preparation options, and not necessarily standardized in size. Vials may be provided with labeling suitable for manual operations, but with potential disadvantages for automated operations such as the disadvantage of obscuring a view into the contents of the vial.

Container assembly: As referred to herein, a “container assembly” may include: a container alone, or a container onto which a container connector is mounted. The term “vial assembly” is used equivalently, although examples embodying aspects of the present disclosure do not necessarily include a vial in a strict sense (e.g., an ampule may be present instead). A septum for at least partially sealing access to the vial can be located as part of the vial itself and/or as part of a container connector (equivalently referred to as a “vial adaptor” or “container adaptor”). The container connector may include a device mountable onto a vial, for facilitating transfer of the vial itself (by grasping onto the adaptor instead of grasping the vial) and/or for facilitating fluid transfer into or from the vial. The container connector may provide protected (e.g., “closed” and/or maintaining sterility) access to the contents of the vial. The container connector may be a single use or multiple use, sterilized device. A vial in a container assembly may be in part obscured from view by elements that attach to it, e.g., manipulators that hold it for manipulations such as shaking or exchange of fluids.

Manipulator: As referred to herein, a “manipulator” may include a structure and/or a mechanism configured to controllably interact with at least one container (e.g., a container loaded onto the system) and/or with other components or structures of the pharmaceutical preparation system. The manipulator can be configured to move the at least one container. The manipulator can be configured to cause or urge fluid transfer processes; for example, transfer fluid from one container to another, involving for example withdrawal of fluid and/or insertion (e.g., injection) of fluid. The manipulator may comprise a robotic arm, a platform, a robotic station, or a combination thereof configured for manipulating the container and/or the fluid transfer assembly. The manipulator can include an actuator, e.g., a motor for facilitating its operation. Certain manipulators are also referred to herein as “agitators”. In some examples, an agitator comprises a manipulator provided with an agitation-specific capability (e.g., a capability for oscillating motions, separate from a capability of the manipulator for selectively positioning manipulated containers in a targeted location). In some examples, the agitator is more simply characterized by being able to secure a container (e.g., a vial) while itself moving in an agitated fashion, e.g., oscillating in position with to impart motion to container contents. In some examples, the agitator moves to impart vortical motion to fluid contents of the container. In some examples, the agitator moves to disrupt a surface boundary region of fluid contents of the container; e.g., to create splashing, and/or momentary droplet separation. In some examples, the agitator generates currents in fluid contents of the container. In some examples, the agitator imparts motion to contents of the vial which induces mixing between two material phases of the contents of the vial, for example, suspending and/or dissolving a solid material into a liquid material, and/or suspending and/or dissolving two liquid material into a common material phase.

Manipulators are not necessarily implemented as “arms” as such, even when described in relation to such terminology. Fluid transfer may occur while a container is engaged (e.g., gripped) by a manipulator. In an example, a manipulator (e.g., a “gripper” or “plunger arm”) can include one or more actuators used in engaging a syringe, and/or pulling or pushing a plunger of a syringe. The syringe may in turn be engaged with a vial. Manipulators are optionally configured to manipulate other types of fluid containers such as vials, IV bags, tubing and/or another suitable container.

Controller: Herein, the equivalent terms “controller” and “controller unit” generally refer to circuitry configured to command some aspect of the behavior of a controlled element, e.g., operation of an actuator (which in turn may be an actuator of a manipulator), operation of a sensor, and/or operation of an imager. The controller, in some examples, comprises computerized circuitry (also referred to herein as “processing circuitry”) configured to perform operations in accordance with a set of instructions stored on a memory readable by the controller, which may be executed, e.g., by a central processing unit (CPU), one or more processors, processor units, and/or microprocessors. Additionally or alternatively, in some examples, the controller uses a digital signal processor (DSP), field-programmable gate array (FPGA), specialized application specific integrated circuit (ASIC), or another device. Additionally or alternatively, in some examples, a controller or controller unit includes one or more analog (e.g., amplifier feedback-based) and/or low-level logic gate-based control circuits. In some examples, the control unit can include one or more mechanism controllers. The controller unit may comprise any means to control elements in the robotic pharmaceutical preparation system and may comprise at least one of analog control circuitry, a synchronizing unit, and a processor.

Imager: Herein, the term “imager” refers to any device which operates to produce an image of some target. “Optical” imaging may typically be understood to include imaging of light including visible light, but this is not necessarily required. For example, infrared and/or ultraviolet wavelengths may be used in imaging additionally or alternatively to visible light wavelengths as appropriate. An example of an imager is an optical camera; e.g., a camera equipped with one or more transparent lenses and a light sensor which can be read out to produce a digital image. Optionally, a scanning imaging method is used, e.g., imaging of reflectance returned to a sensor from a laser illumination scanned over the target. Optionally, interferometric imaging is used, e.g., to track small deformations and/or movements. Imaging using radiant energy other than visible light is not excluded; e.g., acoustic energy, electromagnetic wavelengths outside of the visible spectrum, and/or particle (with mass) radiation imaging. Optionally, contact imaging is performed, e.g., a contact probe is moved along an imaged target to confirm accuracy of its positioning and or measure one or more contours of its shape.

Herein, characteristics and/or values may be referred to as “expected” or “targeted”. It should be understood that these terms refer to technologically embodied representations of appropriate respective states and/or quantities. Optionally, such representations are numeric, e.g., as in the case of targets stored by digital computing circuitry. Optionally, such representations are analog and/or mechanical; for example, represented by a setting of a pointer, knob, weight, or other element or arrangement of elements.

Before explaining at least one embodiment of the present disclosure in detail, it is to be understood that the present disclosure is not necessarily limited in its application to the details of construction and the arrangement of the components and/or methods set forth in the following description and/or illustrated in the drawings. Features described in the current disclosure, including features of the presently disclosed subject matter, are capable of other embodiments or of being practiced or carried out in various ways.

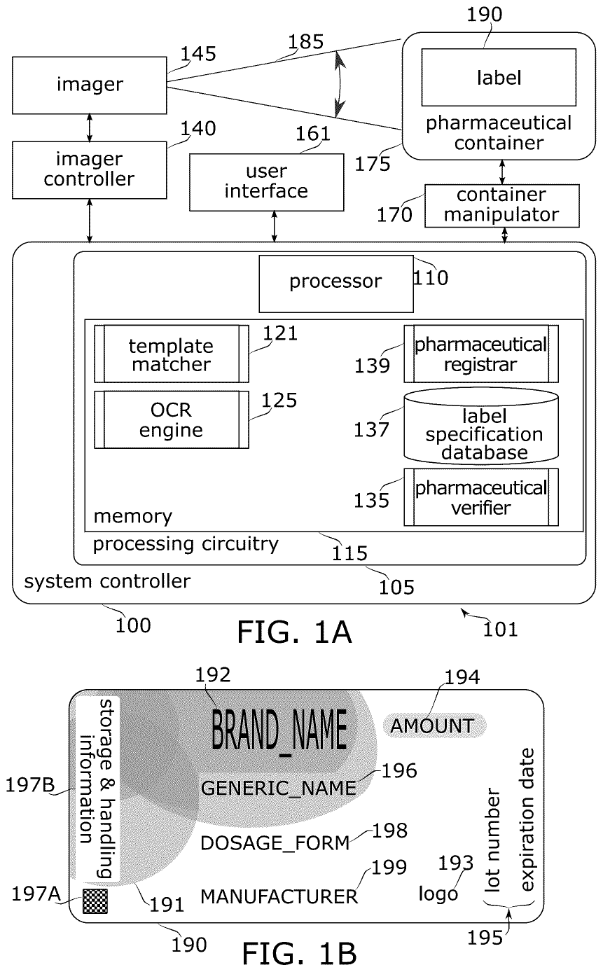

Reference is now made to FIG. 1A, which illustrates an example robotic pharmaceutical preparation system 101, in accordance with some examples of the presently disclosed subject matter.

System controller 100 comprises processing circuitry 105, and is in communication with imager controller 140, which in turn operates imager 145 to image labels 190 of pharmaceutical containers 175, and/or pharmaceutical substance container 175 overall, as these containers are selected for use and/or verification by pharmaceutical preparation system 101. Pharmaceutical preparation system 101 optionally comprises a container manipulator 170 operable to manipulate pharmaceutical container 175 into different positions, e.g., different rotational and/or translational positions with respect to imager 145.

Field of view 185 of imager 145 is optionally selected using movements of imager 145, and/or movements of pharmaceutical substance container 175 to position it for imaging.

Processing circuitry 105 comprises processor 110 and memory 115, which may be configured to perform imager control and/or container manipulation. Additionally, in some examples, memory 115 stores instructions of any one or more of template matcher 121, OCR engine 125, pharmaceutical registrar 139, and pharmaceutical verifier 135. Instructions are carried out by processor 110 during appropriate operations, e.g., as described in relation to FIGS. 2 and 4-7. Memory 115 stores label specification database 137, which is used and/or modified, e.g., as described in relation to FIGS. 2 and 4-7.

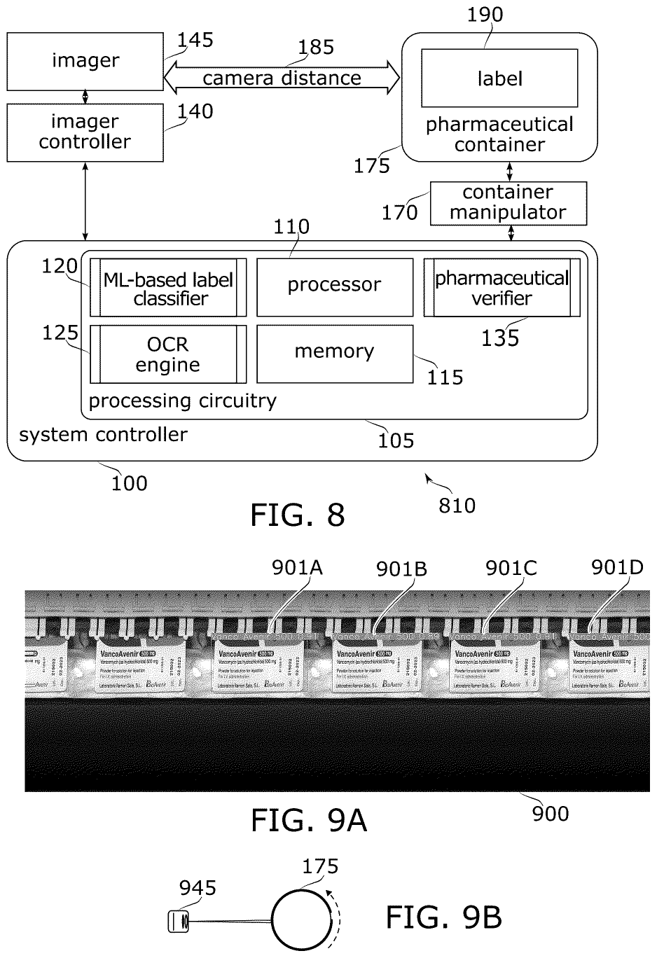

Optionally, pharmaceutical preparation system 101 is implemented as described in relation to FIG. 8 and pharmaceutical preparation system 810, with template matcher 121 implemented as ML-based label classifier 120.

Pharmaceutical preparation system 101, in some examples, is operated under the control of user interface 161.

Reference is now made to FIG. 1B, which schematically illustrates an example of a pharmaceutical container label 190, according to some examples of the presently disclosed subject matter. Text written is placeholder text replacing whatever actual text would be shown on an actual label instance.

Some regions of label 190 are of particular use in identifying and/or verifying a substance contained by the container 175 to which image label 190 is attached. Examples of such regions including textual content are brand name 192, generic name 196, manufacturer name 199, and substance amount indication 194. In some examples, brand name 192, generic name 196, and substance amount indication 194 are required information for establishing the identity of a container 175. In some examples, manufacturer name 199 is used as well, e.g., used if specified for use by a human operator of pharmaceutical preparation system 101.

Label 190 typically contains other fixed information as text and/or as represented by a graphical appearance. Examples shown include QR code 197A, storage and handling information 197B, dosage form 198, and manufacturer logo 193. Other information may be variable for the same label; e.g., lot number and expiration date 195. In some examples, image label 190 includes potentially distinguishing graphical information, such as background shading 191. In some examples, any of this information is optionally used in identification and/or verification of the contents of a container 175.

Reference is now made to FIG. 2, which is a flowchart illustrating a method of registering a label for use by a pharmaceutical preparation system 101, according to some examples of the presently disclosed subject matter.

At block 210, in some examples, pharmaceutical preparation system 101 receives a labelled vial instance for registration as a structured template. Alternatively, in some examples, an existing image (e.g., an image from an on-line regulatory database of pharmaceutical substance labels) is available, in which case the flowchart optionally skips to begin with block 216, or optionally skips to block 212 and then to block 216.

Optionally, at block 212, a specification of vial contents (e.g., contents of a container 175) is received. This may be received, for example, from a database, and/or upon entry at a user interface 161 from a device operator. In some examples, specification of vial contents at block 212 is skipped, and the vial contents are instead specified as part of the operations of block 216 (i.e., directly from information shown on label 190 itself).

At block 214, in some examples, vial or other container 175 is imaged, including imaging of label 190. The images obtained are to be used as registration images in the registration of the structured template. Imaging is performed, e.g., using imager 145 under control of imager controller 140 and/or system controller 100. Optionally, more than one image is obtained. For example, at least three images are optionally obtained, each rotated about 1200 from the previous image, or otherwise rotated in order to ensure that all or substantially all of image label 190 is clearly imaged. In some examples, a line scan imager is used, with imaging being performed substantially continuously while container 175 is being rotated. Optionally more than one set of images is obtained. In some examples, images include views of container 175 overall. This may be useful in determining the shape and/or scale of container 175, which is potentially useful in identifying and/or verifying the contents of container 175.

Optionally, preprocessing is performed on the images obtained in block 214. For example, label images are optionally geometrically normalized to produce a label image which presents the label as if spread out substantially flat, or in another normalized configuration. In some examples, one or more label images are obtained from an existing database of labels; e.g., a database maintained by a regulatory body which regulates pharmaceutical labeling.

At block 216, in some examples, label textual content corresponding to the vial contents specification of block 212 is identified. In some examples, this is performed using OCR. Optionally, input to user 161 is used to provide and/or correct textual content.

The textual content is appropriately assigned field identifications; e.g., identifications of “brand name”, “generic name”, “substance amount”, and/or “manufacturer name”. In some examples, label textual content is itself used to determine the vial contents specification. For example heuristics are used to assign OCR-determined textual and/or graphical content to appropriate field identifications, according to the content identified.

Optionally, there is an opportunity for correction by a human operator of the vial contents specification; e.g., starting from information obtained automatically from the label's textual contents, and/or information in the specification of vial contents at block 212.

At block 218, in some examples, a structured template corresponding to the information identified at block 216 is stored in label specification database 137. The stored information preferably includes both identified textual content (e.g., OCR-identified and/or user provided and/or edited characters) and graphical data from which the textual content was determined, and/or which carries the textual content on the label. Preferably, the two types of information are linked. For example, they may be stored in a joint data structure (distinct from other graphical data/textual content data structures), stored with reference to/by the same field identifier, and/or stored with linkage to identical and/or substantially overlapping region position specifications on the label. Examples of fields are shown, for example, in FIG. 3.

Optionally, registration information for one or more known or partially known labels carrying information related to the information of the label being presently registered is also updated. For example, manufacturer names matching the presently entered label's manufacturer name are optionally updated in the database for records where the manufacture is previously unidentified, and there is a match of manufacturer information such as a similar logo graphic.

Reference is now made to FIG. 3, which schematically illustrates elements assigned to fields of a structured template 220, according to some examples of the presently disclosed subject matter. In particular, the elements for brand name 192, generic name 196, substance amount indication 194, manufacturer name 199, and background shading 191 are shown. In the illustrated example, textual content and graphical content (pixel maps) are shown. In some examples, the position, size and/or shape of pixel maps corresponding to the identified content are also saved as part of the structured template. Optionally, the structured template includes information about the shape of container 175 (e.g., with respect to label 190). Optionally, the structured template includes one or more of the images from which the label registration record was constructed. Overall label size and shape are optionally determined and stored as part of the label registration record.

Reference is now made to FIG. 4, which is a flowchart of a method labeled container verification, according to some examples of the presently disclosed subject matter.

At block 410, in some examples, a labeled instance of a vial (or other container 175) for which contents are to be verified is received (e.g., received by a pharmaceutical preparation system 101).

At block 412, in some examples, container 175 is imaged, including imaging of the label; for example, as described in relation to imaging for image label registration at block 214 of FIG. 2. Optionally, label imaging is optimized for one or more particular structural templates selected as “expected” (e.g., expected based on current settings and/or recent history). For example, imaging is performed to allow normalized images of text in certain regions of the label to be obtained, without necessarily regarding imaging of other regions where relevant text is not expected. If label matching later fails, imaging is optionally re-performed (differently and/or more generically) during a second attempt at label identification.

The operations of blocks 414 and 416 are optionally sequential and/or mixed, depending on implementation details. In some examples, at least one characteristic of the label imaged in block 412 is determined, and one or more structured templates selected for access (and more detailed comparison) based on matching to the determined at least one characteristic. For example, positions of one or more text lines in the label are determined, or textual content itself is determined, e.g., using an OCR engine. In another example, graphical features of the label are determined, e.g., shapes and/or background colors of the label in certain regions. The determined characteristic is used as a lookup value into the set of structured templates available, e.g., in label specification database 137.

Additionally or alternatively, in some examples: from at least one selected structured template (e.g., of label specification database 137), at least one parameter is determined which is used in the analysis of images of the label imaged in block 412. For example, a required position of a region of text is determined, and if there is no text in the region and/or if text in the region is not aligned with the required position, then the label does not match the structured template.

Accordingly, at block 414, in some examples, one or more vial verification templates are accessed (e.g., structured templates as stored in label specification database 137 and/or registered as described in relation to FIG. 2). Optionally, access is to all available structured templates. In some examples, the accessed structured templates are preselected for access, e.g., according to a history of recent matches, and/or a current configuration of a pharmaceutical preparation system 101. In some examples, structured templates are accessed based on a partial characterization of label images from block 212, e.g., based on where text is found in the label images of block 212, based on label sized, and/or based on another characteristic of the label image(s).

At block 416, in some examples, label matching to verification template(s) (that is, to the accessed structured templates of block 414) is performed. Optionally, this comprises any suitable combination of comparison operations. Optionally (e.g., when matching by some comparison criterion is poor), only partial comparisons are performed. In some examples, preliminary stages of comparison are selected to be relatively “cheap” computationally; e.g., comparison is made of where regions of text are located, and/or what text characters are identified in those regions.

In some examples, at least for cases when a structured template is ultimately considered to match a label image, the comparison includes use of both textual content (e.g., textual content determined by OCR), and graphical content at the level of pixel data. For example, there may be comparison of pixel maps underlying corresponding regions with matching textual content. In some examples, matches in textual content are confirmed according to region position.

Optionally, fields of a structured template are matched to label position-corresponding regions in the label images. Optionally, matches to structured template fields are accepted in different (e.g., shifted and/or broadened) regions of the label images. In some examples, field identifications in a structured template are used to constrain the interpretation of textual content in the label; e.g., the field identification optionally restricts the vocabulary used by an OCR engine when identifying text in a certain region of an image of the label.

In comparing textual content, optionally either of an exact or “fuzzy” match between a structured template's text and OCR-identified image text is accepted. In the case of fuzzy matching, one or more character substitutions, omissions, and/or insertions are optionally allowed. Optionally, differences in textual content are weighted or otherwise differentiated according to the nature of the difference. For example, swapping of similarly shaped glyphs like 0 and O may be counted as a less significant error than swapping of very different-looking glyphs. In another example, certain substitutions which merge two glyphs into one may be weighted less, such as w for in.

To compare graphical content (which optionally includes the pixel-level appearance of text without character identification information), any suitable comparison metric and/or method is optionally used. For example, image regions can be compared differentially (e.g., using subtraction and/or division). Optionally, a statistical metric is used, e.g., mean squared error of pixel values. Optionally, normalization is performed before comparison; e.g., normalization to ensure that label regions are suitably comparable to structured template regions in parameters such as position, scale, orientation, contrast, and/or focus quality.

In some examples, images are compared using a machine learning product which has been trained to report whether or not two pixel maps are produced from images of the same label type (e.g., whether they are each imaged instances of a particular label, including formatting and textual content). In some examples, the pixel maps are tested for being corresponding sub-regions of the label. In some examples, a pixel map (e.g., of a structured template) is tested for being a sub-region of a label image overall. In some examples, training data include images of the same label type with variable information such as varied lot number and/or expiration date. In some examples, training data include images of the same label type under different conditions of lighting, orientation, and/or focus. In some examples, training data include images of the same label type with different flaws; e.g., creasing, bubbling, mis-orientation, and/or missing or otherwise damaged areas.

In some examples, label matching is required in particular for certain fields of the structured template. For example, brand name, generic name, and substance amount may be required. Optionally, manufacturer name is matched. In some examples, additional fields of a structured template are provided and matched. For example, when there is a potential risk of cross-identification of two similarly structured labels (e.g., labels of a type having nearly the same textual content for required fields), it is a potential advantage to require matching of additional information in order to reduce a risk of misidentification.

Optionally, full comparisons are performed for some structured templates based on how similar they are to a current “best matching” structured template, in order to increase confidence that the best match is significantly closer than for any potentially competing match. Such similarity is determined based on any suitable metric, e.g., Hamming distance, or a related metric such as Hamming distance adjusted by weightings of error significance.

Optionally, the operations of blocks 414 and 416 are repeated for a plurality of images of an image label 190 of container 175. This potentially helps to decrease the chances that label 190 is misidentified due to an imaging flaw; for example, a line scanning error, an illumination artifact, and/or a transient electrical artifact.

Optionally, at block 418, in some examples, the label identification which was determined in blocks 414-416 is compared to required contents of container 175. For example, expected contents of container 175 may be referenced (directly or indirectly) in a digitally specified protocol for mixing a pharmaceutical preparation by pharmaceutical preparation system 101. Additionally or alternatively, identifying and/or verification information for container 175 may be provided separately from and/or along with preparation protocol information.

In some examples, if there is a mismatch between requirements and the actually determined identity of the label 190 of container 175, an alert is raised. In some examples, a correct match to requirements is required before further operations of pharmaceutical preparation system 101 using container 175 are allowed to proceed.

Reference is now made to FIG. 5, which is a flowchart of a method of label identification and/or verification, according to some examples of the presently disclosed subject matter. The operations of blocks 510-516, in some examples, correspond to the operations of blocks 414-416 of FIG. 4. In some examples, the operations of blocks 510-514 correspond to the operations of blocks 214-216 of FIG. 2 (template registration).

At block 510, in some examples, at least one label image is accessed. This can be an image of a label which is being registered (e.g., as part of the operations of the method of FIG. 2), or an image of a label image label 190 of a container 175 which is being identified and/or verified as part of pharmaceutical preparation operations, e.g., as part of the method of FIG. 4.

As noted previously, the label image is optionally a single image constructed from a plurality of images. Optionally the label image is normalized to facilitate comparisons with other images as appropriate. Optionally several images are accessed, so that blocks 512-514 (for example) can be repeated to verify consistency.

At block 512, in some examples, textual content of the label 190 is determined using an OCR engine. The textual content is optionally associated with the particular image location(s) it is identified from.

At block 514, in some examples, graphical appearance of the label 190 is characterized. The characterization optionally comprises selecting pixel map data (e.g., intensity data) from the region(s) in which the OCR engine identified text. Optionally, the pixel map data itself is used as the characterization of graphical appearance. Optionally, the pixel map data is summarized, abstracted, converted into a vector representation of its features, and/or otherwise transformed.

At block 516, in some examples—if the method is being performed as part of container verification template registration (e.g., as part of the method of FIG. 2), the textual content and graphical appearance data are stored. Optionally, textual content and graphical appearance data are linked through a common label region to which they related. Optionally, more than one field of textual content is stored; e.g., a field for each of a plurality of different pharmaceutical substance properties, such as substance brand name, substance generic name, substance amount, and/or substance manufacturer.

Alternatively at block 516—if the method is being performed as part of the identification and/or verification of a particular container 175 and label 190, comparison with one or more container verification templates is carried out using determined textual content and graphical appearance determined in blocks 512-514. Again, there may be more than one field involved in the comparison, and different fields of textual content may be distinctly associated with different meanings, as described for verification template registration.

Comparison optionally makes reference to (and use of) textual content and graphical appearance in any suitable order, including mixed orders. For example, computationally inexpensive comparisons may be carried out first in order to exclude most container verification templates from further consideration, with full sets of comparisons being performed only for some or all of the templates that remain. Optionally comparison of all features is substantially simultaneous (e.g., performed by parallel processing).

Matching of textual content is optionally exact; or permissive of a certain amount of error (e.g., character omission, insertion, or substitution, of the type which is consistent with OCR errors which may from time to time occur).

Matching of graphical appearance can be performed in any one or more of several ways. For example, pixel map data may be directly compared, optionally after suitable normalization to remove and/or minimize imaging variability. Methods of comparing pixel map data include, for example, differential methods, statistical methods, and methods that identify feature locations such as edges and/or corners, their orientations, and/or another metric characterizing an arrangement of image features. In some examples, pixel map data is abstracted, e.g., to histogram data, or otherwise “fingerprinted”.

Optionally, a machine learning-based set of weightings is used to classify graphical appearance of the label as “like” or “unlike” a given container verification template, and/or to classify its appearance selected from among any number of container verification templates. In some examples, graphical appearance is characterized by a vectorization of an image region, e.g., a vectorization to an eigenvector, with component magnitudes indicating strength with which certain eigenvalues (“features”) are represented in the image region.

Optionally, complete comparison is carried through for at least one imperfectly matching template in order to confirm that there is a low likelihood that any template except the best-matching template is the correct template. Optionally, the best-matching template is simply considered the correct template—e.g., insofar as no other option may be considered as remaining. Alternatively, e.g., in case that the best-matching template is not sufficiently similar to the textual content and/or graphical appearance of the container label 190 being evaluated, the result may be reported as a failure to identify the container 175 and/or its contents.

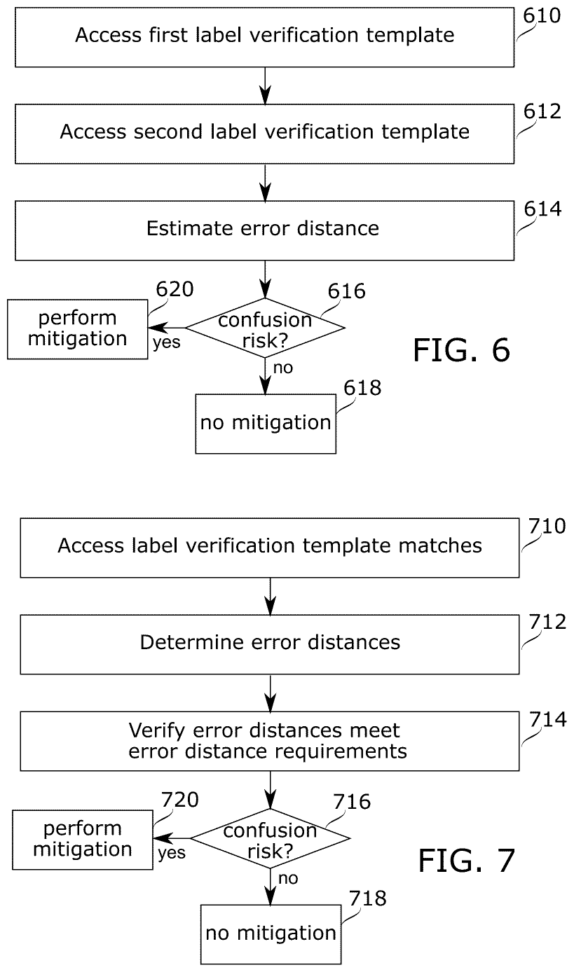

Reference is now made to FIG. 6, which is a schematic flowchart of a method of adjusting registered label verification templates for distinctness, according to some examples of the presently disclosed subject matter.

As part of risk assessment and/or mitigation, it may be useful to perform checks which characterize the “error distance” between two label verification templates (that is, two different container verification templates; the two terms should be considered interchangeable). The error distance may be understood as characteristic of the number of errors which must be made before one label template could be confused for another. Optionally, mitigation is performed in order to increase the error distance, e.g., between to initially close label templates.

At block 610, in some examples, a first label template is accessed. At block 612, in some examples, a second label template is accessed. At block 614, in some examples, an error distance between the two label templates is determined.

Considering textual content, error distance may be readily calculated as the number of character insertions, deletions and/or substitutions which must be performed in order to, in effect, convert the textual content of one of the label templates into the textual content of another. Optionally, some errors are weighted more or less strongly, e.g., depending on their likelihood (e.g., substitution of o for 0 or 1 for 1 may be considered a more likely substitution, giving a relatively lower contribution to error distance, compared to substitution of characters with glyphs unlike each other). Error distance is optionally calculated separately for different fields of data.

Considering graphical appearance data, error distance may be calculated according to a metric suitable to the representation of the graphical appearance data itself. This can include direct conversion of one template's data into the other; e.g., calculating the absolute value sum of changes in pixel values, measuring histogram value differences, or determining vector component differences.

At decision block 616, in some examples, a determination is made as to whether or not there is a significant risk of confusion between the two label templates. The risk is optionally assessed for a notional comparison using an instance of a label. For example, if a selected (e.g., assumed or observed) level of “error noise” in comparison accuracy is likely to induce error with a value of ½ the error distance between two label templates, then it can be foreseen that in some cases, an ambiguous conclusion would result.

If the determination of block 616 indicates likely instances confusion, then optionally, at block 620, a mitigation action is performed. One general category of such mitigation actions is to add one or more additional features to one or both of the label templates. This is optionally performed automatically (e.g., using textual content of secondary importance and/or a selected graphical appearance metric such as color or overall label size). Additionally or alternatively, an operator may be prompted to provide a feature indication, such as a region of interest which is differentiating between the two label templates.

Another general category of mitigation actions is to “flag” one or both templates for extra attention, so that when they are matched with sufficient ambiguity, an action will be taken later on.

If the error distance is considered not to involve significant risk, then optionally the flowchart concludes at block 618 with no mitigation being performed.

Reference is now made to FIG. 7, which is a schematic flowchart of a method of detecting confusion risk during label template matching, in accordance with some examples of the presently disclosed subject matter.

At block 710, in some examples, a plurality of verification template matches is accessed. These are optionally determined with respect to an instance of a container 175 and its label 190, e.g., as described in relation to FIGS. 4-5 and/or in the overview section. At block 712, in some examples, error distances are determined. For example, error distances are determined between matching templates as such, and/or between matching templates and the container label instance being evaluated. Error distance is optionally calculated, e.g., as described in relation to FIG. 6, and/or in the overview section. At block 714, in some examples, the calculated error distances are compared to requirements. For example, it may be required that there is no statistical risk of a certain misidentification above a certain threshold. Optionally, some misidentification scenarios are considered more critical than others, and the threshold for concern strengthened accordingly.

At decision block 716, in some examples, if the error distances determined are considered not to involve significant risk, then optionally the flowchart concludes at block 718 with no mitigation being performed.

Alternatively, at block 720 a mitigation may be performed. Optionally, this comprises halting automatic operations and/or raising an alert to an operator, informing them of the potential confusion. Optionally, the operator is empowered (e.g., by operation of a user interface) to accept, reject, or correct an apparently ambiguous identification made by a pharmaceutical preparation system. Optionally, the operator is required to acknowledge the ambiguous situation, along with clearing and/or resetting the error condition, before the system proceeds with its operations.

Reference is now made to FIG. 8, which illustrates an example robotic injection pharmaceutical preparation system 810 with machine learning-based verification of pharmaceutical properties, in accordance with some examples of the presently disclosed subject matter.

System controller 100, in some examples, includes processing circuitry 105; comprising, e.g., processor 110 and memory 115.

Processor 110 can be a suitable hardware-based electronic device with data processing capabilities, such as, for example, a general purpose processor, digital signal processor (DSP), a specialized Application Specific Integrated Circuit (ASIC), one or more cores in a multicore processor, etc. Processor 110 can also comprise, for example, multiple processors, multiple ASICs, virtual processors, combinations thereof, etc.

Memory 115 optionally includes any suitable kind of volatile and/or non-volatile storage; for example, a single physical memory component or a plurality of physical memory components. Memory 115 can be configured to, for example, store data used in computation, and/or store instructions. It may itself include a non-transitory computer-readable storage medium.

Processing circuitry 105 can be configured to execute any one or more of several functional modules; in accordance with computer-readable instructions stored on a non-transitory computer-readable storage medium. Such functional modules are referred to hereinafter as comprised in the processing circuitry. These modules can include, for example, label machine learning-based label classifier 120, optical character recognition (OCR) engine 125, and pharmaceuticals verifier 135.

Pharmaceutical substance container 175 can be held or manipulated by an appropriate mechanism, such as a gripper or a robot arm. Optical character recognition (OCR) engine 125 can perform optical character recognition on received images of label 190 of pharmaceutical substance container 175. OCR engine 125 can, for example, generate text strings from the characters that it reads from pharmaceutical label 190.

Machine learning-based label classifier 120 can utilize a trained machine learning model to determine pharmaceutical parameters associated with a label of a pharmaceutical product. Label classifier 120 may be understood as a specific example of a template matcher 121, e.g., as described in relation to FIG. 1A. In some examples, machine learning-based label classifier 120 receives label images, and from them generates data indicative of pharmaceutical parameters associated with the labels used in the training phase.

System controller 100 can be operably connected to a container manipulator 170; for example, connected via a bus or a network. In some examples, system controller 100 can command container manipulation operations; for example, command container manipulator 170 to position pharmaceutical container 175 for imaging by imager 145 (e.g. position it at the camera distance of field of view 185). Other operations performed on container 175 optionally include picking it up, putting it down, and positioning it for substance transfers; e.g., transfers of fluid from and or into a syringe, with which container 175 may be transiently connected as part of pharmaceutical preparation.

System controller 100 can be operably connected to a syringe-manipulation subsystem (not shown); for example, connected via a bus or a network. In some examples, system controller 100 can command syringe-manipulation subsystem operations; for example, command it to draw a specific quantity (e.g. volume) of a fluid (such as a medication to be injected into a patient) into a syringe barrel (not shown).

Imager 145, in some examples, comprises a digital camera configured to optically scan, for example, label 190 of pharmaceutical substance container 175. In some examples, imager 145 is a line-scan camera which moves laterally or rotationally relative to label 190 to photograph different parts of label 190 (the label 190, the camera 145, or both may move), and then supplies these to imager controller 140, which performs image processing to fuse the series of photographs into a single image (e.g. a panoramic image).

Imager controller 140 can be operably connected to imager 145 and to system controller 100.

Imager 145 can be positioned so that it captures a digital image of the pharmaceutical container from a particular distance that is herein termed imager distance of field of view 185.

Imager controller 140 can be operably connected to imager 145. Imager controller can implement imager control methods, and can supply digital images to system controller 100.

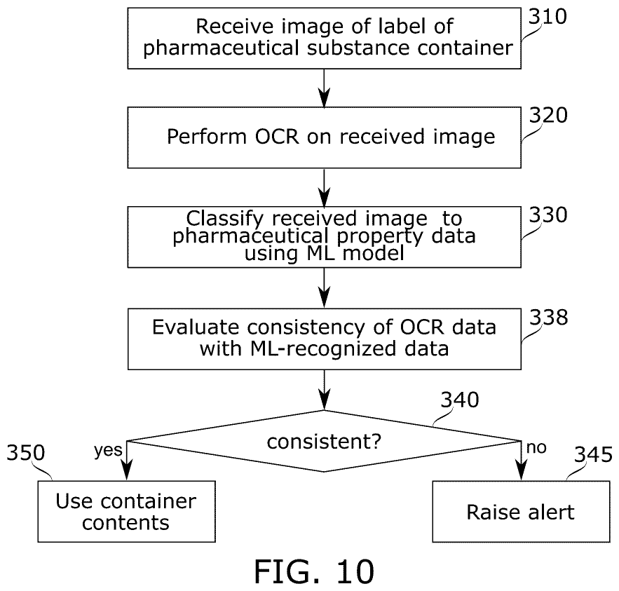

System controller 100 can be operably connected to imager controller 140, and can implement system control methods such as those described below with reference to FIG. 10.

Reference is now made to FIG. 9A, which illustrates an example image 900 of a label of a pharmaceutical container, in accordance with some examples of the presently disclosed subject matter. Reference is also made to FIG. 9B, which illustrates rotation of a container 175 in front of a line-scanning camera 945, in accordance with some examples of the presently disclosed subject matter. In the example shown, a line scan camera 945 has been operated while a labeled container 175 is rotated several times before it. Some of the image repetitions 901A-901D are labeled with a portion of the identified text, followed by a confidence score.

Reference is now made to FIG. 10, which illustrates a flow diagram of an example sequence of machine learning-based verification of pharmaceutical properties in a robotic injection preparation system, in accordance with some examples of the presently disclosed subject matter.

At block 310, in some examples, processing circuitry 105 (e.g. pharmaceuticals verifier 135) receives an image of a label of a pharmaceutical substance container from, for example, imager controller 140.

At block 320, in some examples, processing circuitry 105 (e.g. OCR engine 125) performs OCR on the received image. The OCR can result in various text strings signifying pharmaceutical properties such as:
Name of pharmaceutical
Manufacturer
Quantity
Manufacturer date
Lot #
Expiration date

Processing circuitry 105 can utilize these pharmaceutical properties for various purposes.

By way of non-limiting example: processing circuitry 105 can perform preparation of a pharmaceutical injection in a particular sequence when a smaller container is provided (e.g., a container holding a relatively smaller amount of a pharmaceutical substance), and a different manner when a larger container is utilized.

Moreover, processing circuitry 105 can perform critical safety checks on the basis of the resulting text strings e.g. detecting an incorrect or expired pharmaceutical.

However, as described above, text generated by OCR mechanisms can include errors due to causes such as label damage, lighting issues etc.

At block 330, in some examples, processing circuitry 105 (e.g. machine learning-based label classifier 120) classifies the received image, e.g. using a machine learning model which classifies labels images to pharmaceutical property data (for example: using a machine learning model trained as described above). Pharmaceutical properties resulting from this classification can include, for example:
Name of pharmaceutical
Manufacturer
Quantity
Manufacturer date
Lot #
Expiration date

Additionally or alternatively, the classification determines an identity of the container, and from the identity of the container, pharmaceutical properties may be determined, e.g., by look-up.

At block 338, in some examples, processing circuitry 105 (e.g. pharmaceuticals verifier 135) determines whether the pharmaceutical properties and/or identification resulting from machine learning classification of the label are consistent with the OCR-determined text strings. For example: in some examples, the pharmaceutical properties resulting from classification can be provided as text strings, and processing circuitry 105 (e.g. pharmaceuticals verifier 135) can determine whether the text strings are identical. In some other examples, processing circuitry 105 (e.g. pharmaceuticals verifier 135) can confirm that the manufacturer indicated by classification is the same manufacturer indicated by the OCR text string; etc.

From decision block 340, in some examples: if processing circuitry 105 (e.g. pharmaceuticals verifier 135) detects a lack of consistency between the determined pharmaceutical parameters and the OCR-derived text strings, it can raise an alert at block 345. Otherwise, at block 350, it can continue processing (e.g. use the container's contents).

### General

As used herein with reference to quantity or value, the term “about” means “within ±10% of”.

The terms “comprises”, “comprising”, “includes”, “including”, “having” and their conjugates mean: “including but not limited to”.

The term “consisting of” means: “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

The words “example” and “exemplary” are used herein to mean “serving as an example, instance or illustration”. Any embodiment described as an “example” or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the present disclosure may include a plurality of “optional” features except insofar as such features conflict.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

Throughout this application, embodiments may be presented with reference to a range format. It should be understood that the description in range format is merely for convenience and brevity and should not be construed as an inflexible limitation on the scope of descriptions of the present disclosure. Accordingly, the description of a range should be considered to have specifically disclosed all the possible subranges as well as individual numerical values within that range. For example, description of a range such as “from 1 to 6” should be considered to have specifically disclosed subranges such as “from 1 to 3”, “from 1 to 4”, “from 1 to 5”, “from 2 to 4”, “from 2 to 6”, “from 3 to 6”, etc.; as well as individual numbers within that range, for example, 1, 2, 3, 4, 5, and 6. This applies regardless of the breadth of the range.

Whenever a numerical range is indicated herein (for example “10-15”, “10 to 15”, or any pair of numbers linked by these another such range indication), it is meant to include any number (fractional or integral) within the indicated range limits, including the range limits, unless the context clearly dictates otherwise. The phrases “range/ranging/ranges between” a first indicate number and a second indicate number and “range/ranging/ranges from” a first indicate number “to”, “up to”, “until” or “through” (or another such range-indicating term) a second indicate number are used herein interchangeably and are meant to include the first and second indicated numbers and all the fractional and integral numbers therebetween.

Although descriptions of the present disclosure are provided in conjunction with specific embodiments, it is evident that many alternatives, modifications and variations will be apparent to those skilled in the art. Accordingly, it is intended to embrace all such alternatives, modifications and variations that fall within the spirit and broad scope of the appended claims.

It is appreciated that certain features which are, for clarity, described in the present disclosure in the context of separate embodiments, may also be provided in combination in a single embodiment. Conversely, various features, which are, for brevity, described in the context of a single embodiment, may also be provided separately or in any suitable subcombination or as suitable in any other described embodiment of the present disclosure. Certain features described in the context of various embodiments are not to be considered essential features of those embodiments, unless the embodiment is inoperative without those elements.

It is the intent of the applicant(s) that all publications, patents and patent applications referred to in this specification are to be incorporated in their entirety by reference into the specification, to the same extent as if each individual publication, patent or patent application was specifically and individually noted when referenced that it is to be incorporated herein by reference. In addition, citation or identification of any reference in this application shall not be construed as an admission that such reference is available as prior art to the present disclosure. To the extent that section headings are used, they should not be construed as necessarily limiting. In addition, any priority document(s) of this application is/are hereby incorporated herein by reference in its/their entirety.

1. A method of identifying a pharmaceutical substance, comprising:
accessing at least one image of a label of a pharmaceutical substance container;
characterizing the image to produce an indication of graphical appearance using a machine learning product;
accessing one or more label templates, data of each label template including:
textual content of a region of a reference label, and
at least one indication of graphical appearance in the region of the reference label, said at least one indication of graphical appearance also produced by said machine learning product;
comparing the image to the one or more label templates, including comparison to both the textual content and comparison of the respective indications of graphical appearance; and
determining an identity of the pharmaceutical substance in accordance with results of the comparing.

2. The method of claim 1, wherein the textual content includes at least one of a generic name of the pharmaceutical substance, and a brand name of the pharmaceutical substance.

3. The method of claim 1, wherein the textual content specifies an amount of the pharmaceutical substance contained in the container.

4. The method of claim 3, wherein the amount is specified by both a number and a unit indication.

5. The method of claim 1, wherein the textual content names a manufacturer of the pharmaceutical substance.

6. The method of claim 1, wherein each label template encodes the textual content as digital sequence of code points.

7-8. (canceled)

9. The method of claim 1, wherein the at least one indication of graphical appearance comprises an eigenvector for a set of eigenvalue features.

10. The method of claim 1, wherein the comparing includes determining label information used in the comparison, and the determining label information includes determining at least some textual content displayed in the image of the label, and determining an indication of graphical appearance in the image of the label.

11. The method of claim 10, wherein both the determined textual content and the determined indication of graphical appearance are derived from a same region of the image of the label.

12-14. (canceled)

15. The method of claim 1, wherein the textual content of each label template is assigned in respective portions to each of a plurality of fields of the data of the label template, each field also comprising a field identity.

16. The method of claim 15, wherein each field is associated with a region of the reference label including its respective portion of textual content.

17. The method of claim 16, wherein each field is associated with a respective one of the at least one indications of graphical appearance, ad the respective indication of graphical appearance is indicative of graphical appearance in the associated region of the reference label.

18-20. (canceled)

21. The method of claim 1, comprising normalizing the at least one image for comparison with the one or more label templates, according to a three dimensional structure of the pharmaceutical substance container.

22-23. (canceled)

24. The method of claim 1, wherein:
the comparing comprises:
determining that there is a partial mismatch in textual content between one of the one or more label templates, compared to textual content identified in the at least one image of the label, and
determining that there is a sufficient correspondence of the at least one image of the label with one of the at least one indications of appearance in the region of reference label; and
the determining the identity of the pharmaceutical substance assigns an identity associated with said one of the one or more label templates, despite the partial mismatch in textual content.

25-27. (canceled)

28. The method of claim 1, wherein the accessing one or more templates comprises accessing at least a first template, according to a tentative identity of the pharmaceutical substance, and at least a second template, according to a similarity of the second template to the first template.

29. (canceled)

30. A system for pharmaceutical substance preparation, the system comprising a processor and memory, wherein the memory includes instructions which instruct the processor to:
access at least one image of a label of a pharmaceutical substance container;
characterizing the image to produce an indication of graphical appearance using a machine learning product;
access one or more label templates, data of each label template including:
textual content of a region of a reference label, said at least one indication of graphical appearance also produced by said machine learning product;
at least one indication of graphical appearance in the region of the reference label;
compare the image to the one or more label templates, including comparison to both the textual content and comparison of the respective indications of graphical appearance; and
determine an identity of the pharmaceutical substance in accordance with results of the comparison.

31. The system of claim 30, comprising an imager and an imager controller; wherein the memory includes instructions which instruct the processor to control an image controller to image the at least one image of the label.

32. The system of claim 30, comprising a manipulator configured to manipulate the pharmaceutical substance container; wherein the memory includes instructions which instruct the processor to control the manipulator to position the label to be imaged in the at least one image of the label.

33-54. (canceled)

55. The method of claim 1, wherein the machine learning product is trained by feedback received responsive to categorizations of pharmaceutical substance label examples, and the categorizations are responsive to label type and/or non-textual label features.

56. The system of claim 30, wherein the machine learning product is trained by feedback received responsive to categorizations of pharmaceutical substance label examples, and the categorizations are responsive to label type and/or non-textual label features.
